(19) United States
(12) Patent Application Publication
(10) Pub. No.: US 2005/0247855 A1
(43) Pub. Date: Nov. 10, 2005

(54) Optical pickup apparatus

(76) Inventors: Hiroaki Matsumiya, Osaka (JP); Kazuo Momoo, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/114,826

(22) Filed: Apr. 26, 2005

(30) Foreign Application Priority Data
Apr. 27, 2004 (JP) 2004-130967
Apr. 28, 2004 (JP) 2004-133109

(51) Int. Cl. G02B 7/04

(52) U.S. Cl. 250/201.5

(57) ABSTRACT

An optical pick up apparatus includes: a first, a second and a third light emitting points for emitting light beams; an optical system for introducing the light beams emitted from the first, second and third emitting points to an objective lens; an objective lens for converging the light beams introduced by the optical system onto an information recording medium; and a light detector for detecting reflected light from the information recording medium, wherein a relationship of λ1<λ2<λ3 is satisfied, where λ1, λ2 and λ3 denote the respective wavelengths of the light beams emitted from the first, second and third light emitting points, and a relationship of either L1=L2<L3 or L1<L2=L3 or L1<L2<L3 is satisfied, where L1, L2 and L3 denote the respective distances between a reference axis which optically matches a center axis of the objective lens and the first, second and third light emitting points.

### BACKGROUND OF THE INVENTION

1. Field of the Invention

The present invention relates to an optical pickup apparatus for optically performing a recording operation or reproduction operation for an information recording medium such as an optical disc, and the like, using a laser light source.

2. Description of the Related Art

As formats of optical discs have become diversified, in order to realize a single pickup apparatus for performing a recording operation or a reproduction operation for a plurality of optical discs having a plurality of different formats, an optical pickup apparatus including a plurality of light sources, for example, a light source of 790 nm (or 780 nm) wavelength band for CD and a light source of 650 nm (or 635 nm) wavelength band for DVD, has been developed.

Furthermore, in recent years, optical discs having a higher recording density have been developed and a semiconductor laser having a light source for emitting a light beam having a wavelength band of around 400 nm for recording/reproduction, which is different from the wavelength bands mentioned above, has been used.

Japanese Laid-Open Publication No. 11-339307 (page 4, Figure 1) proposes an optical pickup apparatus operable for three or more different optical discs.

However, in an optical pickup apparatus for performing a recording operation or a reproduction operation for all of the plurality of optical discs, it is necessary to prepare a laser light source for every optical disc having a different format. This increases the number of parts for the optical pickup apparatus. As a result, the integrated density of the composition parts, such as a laser light source, cannot be increased. This prevents reducing the size and/or cost of the optical pickup apparatus.

As a conventional pickup apparatus for use with optical discs with the plurality of different formats, FIG. 4 shows a structure f an optical system of an optical pickup apparatus for use with optical discs with three formats (i.e. a high-density optical disc, DVD and CD).

In FIG. 4, 401 denotes a laser light source for a high-density optical disc, 402 denotes a laser light source for a DVD, 403 denotes a laser light source for a CD.

A laser light source 401 emits a light beam 40a for a high-density optical disc from a light emitting point 4a. A laser light source 402 emits a light beam 40b for a DVD from a light emitting point 4b. A laser light source 403 emits a light beam for a CD from a light emitting point 4c.

The light beams 40a, 40b and 40c are transmitted or reflected by the beam splitters 404 and 405 and are incident to a polarization beam splitter 406. The light beams 40a, 40b and 40c are transmitted through a polarization film of the polarization beam splitter 406, converted into collimated light beams by a collimating lens 407. The collimated light beams is transmitted through a ¼ wavelength plate 408, and are converged onto the respective the high-density disc 410a, the DVD 410b and CD 410c by the objective lens 409 so as to form the respective light spots on the respective the high-density disc 410a, the DVD 410b and CD 410c.

The light beams reflected by the optical discs 410a, 410b and 410c are transmitted through the objective lens 409 and the ¼ wavelength plate 408, are reflected by the polarization film of the polarization beam splitter 406, and are converged onto a light detector 412 by a converging lens 411. The light detector 412 can detect various signals such as a focusing error signal, a tracking signal, and the like.

In an optical pickup apparatus for performing a recording operation or a reproduction operation for all of the plurality of optical discs, it is necessary to prepare a laser light source for every optical disc having a different format. This increases the number of parts for the optical pickup apparatus. As a result, the integrated density of the composition parts, such as a laser light source and a light detector, cannot be increased. This prevents reducing the size and/or cost of the optical pickup apparatus.

For example, Japanese Laid-Open Publication No. 2002-025194 (page 3, FIG. 5) proposes integration of light sources such as semiconductor lasers onto a common substrate.

As a conventional optical pickup apparatus for optical discs with the plurality of different formats, as shown in FIG. 9, a method for using a light source module for three wavelengths is proposed. The light source module includes a semiconductor laser 1501, which is a light source for an optical disc with a high density, and a monolithic semiconductor laser 1502, which is a light source for DVD and CD. The semiconductor lasers 1501 and 1502 are mounted on a common substrate 1500.

As shown in FIG. 9, in the light module 1050, the light beam 1052a for a high-density optical disc is emitted from the light emitting point 1051a of the semiconductor laser 1501, the light beam 1052b for a DVD is emitted from the light emitting point 1051b of the semiconductor laser 1502, and the light beam 1052c for a CD is emitted from the light emitting point 1051c of the semiconductor laser 1502.

The light beams 1052a, 1052b and 1052c are reflected by a reflective surface 1503 provided on the substrate 1500. As a result, the light beams 1052a, 1052b and 1052c are emitted approximately parallel in a direction perpendicular to the common substrate 1500 from light emitting points 1502a′, 1502b′ and 1502c′ which are equivalent to the light emitting points 1051a, 1051b and 1051c.

Hereinafter, the equivalent light emitting points 1502a′, 1502b′ and 1502c′ are treated as light emitting points of the light source module 1050.

FIG. 10 shows a structure of an optical system for an optical pickup apparatus including the light source module 1050. The optical pickup apparatus is used for optical discs having three different formats (i.e. a high-density optical disc, a DVD and a CD).

The light beam 1060a for a high-density optical disc is emitted from the light emitting point 1051a′, the light beam 1060b for a DVD is emitted from the light emitting point 1051b′, and the light beam 1060c for a CD is emitted from the light emitting point 1051c′.

The light beams 1060a, 1060b and 1060c are transmitted through the beam splitter 1601 and are converted into collimated light beams by a collimating lens 1602. The collimated light beams are transmitted through a ¼ wavelength plate 1603, and are converged onto the respective the high-density disc 1605a, the DVD 1605b and CD 1605c by the objective lens 1604 so as to form the respective light spots on the respective the high-density disc 1605a, the DVD 1605b and CD 1605c.

The light beams reflected by the optical discs 1605a, 1605b and 1605c are transmitted through the objective lens 1604 and the ¼ wavelength plate 1603, are reflected by the polarization film of the polarization beam splitter 1601, and are converged onto a light detector 1607 by a converging lens 1606. The light detector 1607 can detect various signals such as a focusing error signal, a tracking signal, and the like.

However, in FIG. 4, the light beams 40a, 40b and 40c emitted from the light sources 401, 402 and 403 are incident on the optical discs 410a, 410b and 410c having the different formats, respectively. This requires a number of optical parts such as a beam splitter.

Further, in order to realize a desired recording/reproduction performance for an optical disc, it is necessary to increase the quality of the light spot by reducing the aberration of the light spot on the optical disc. In FIG. 4, it is necessary to adjust the laser light sources 401, 402 and 403 for two or more axes such that the light beams 40a, 40b and 40c passing through the light emitting points 4a, 4b and 4c and the principal point of the collimating lens 407 approximately match the center axis of the objective lens 409.

According to the optical pickup apparatus having the structure mentioned above, the number of component parts is increased and the number of the parts required for adjustment is increased. This prevents reducing the size and/or cost of the optical pickup apparatus.

In general, as an optical disc for recording/reproduction has a format having a higher density, it is required to realize higher quality of a light spot. The higher quality of the light spot can be realized, for example, by reducing aberrations of the light spot formed on the optical disc, using a semiconductor laser for emitting a light beam having a shorter wavelength and/or an objective lens having a higher numerical aperture.

In the example shown in FIG. 10, it is required to minimize the aberrations of the light spot formed from the light beam 1060a, which is the shortest wavelength, for the high-density optical disc 1605a, which has a format having the highest density, and to manage the quality of the light spot at the highest precision and the highest accuracy.

In this case, when the objective lens having a high numerical aperture shown in FIG. 10 is used to converge the light beams to form a light spot, as the angle between the center axis 1600 of the objective lens 1604 and the light beam 1060a passing through the light emitting point 1051a′ and the principal point of the collimating lens 1602 becomes larger, the aberrations of the light spot formed by converging the light beam onto the optical disc using the objective lens 1106 is increased so as to form a distorted light spot. As a result, the quality of the light spot and the recording/reproduction performance are degraded.

Accordingly, in FIG. 10, the light source module 1050 is configured after adjustment of two or more axes, such that, the light beam 1060 passing through the light emitting point 1061a and the principal point of the collimating lens 1602, is incident on the objective lens 1604 with almost zero angle (i.e. such that the light emitting point 1051a′ is located on the center axis 1600 of the objective lens 1604). Thus, the light source module 1050 can be configured to minimize the aberrations of the light spot formed from the light beam 1060a and to optimize the quality of the light spot.

However, because the light emitting points 1051a′, 1051b′ and 1051c′ on the light module 1050 are placed with limited distance from each other, for the reason mentioned above, to make the light spot the light beam 1060a for the high density optical disc forms small, when the light source module is regulated so that the light beam 1060 emitted from the light emitting point 1051a′ is placed approximately on the center axis of the objective lens 1604, the light beam 1060, which connects the other light emitting points 1051b′ and 1050c′ and the principal point of the collimating lens 1602 enters the objective lens 1605 with certain angles α, β. Accordingly, with the reason mentioned above, there are problems that aberration at a light spot formed on DVD 1605b, CD 1605c occurs and the quality of the light spot degrades and recording/reproduction performance degrades.

Especially, a light beam, which passes the light emitting point 1051c′ placed at the position the farthest from the light emitting points 1051a′ and the principal point of the collimating lens 1602, enters the objective lens with a large angle, and the light spot formed on the CD 1605c becomes a distorted light spot with aberration largely occurred and recording/reproduction performance of CD 1605c degrades largely.

The present invention is made focusing attention on the problems mentioned above and aims to provide a simple and compact optical pickup apparatus, which meets recording/reproduction performance of an information recording medium with a plurality of formats, with low cost, sufficiently securing recording/reproduction performance for an information recording medium with the highest-density, able to secure recording/reproduction performance of an information recording the other two light emitting points correspond to, in a light source module with simple composition which has integrated a plurality of light emitting points.

Furthermore, the present invention is to provide a compact and low-cost optical pickup apparatus with simple composition with fewer regulation parts with fewer composition parts, sufficiently securing recording performance at the fastest speed, able to secure recording/reproduction performance of an information medium the other two light emitting points correspond to and possible to realize recording/reproduction performance of an information recording medium with plurality of formats in a light source module, which has integrated a plurality of light emitting points, with simple composition.

Furthermore, the present invention is to provide a compact and low-cost optical pickup apparatus, possible to realize make low-cost of a light source module.

In addition, the present invention is to provide a compact and low-cost optical pickup apparatus, despite mounting a plurality of light emitting points, possible to secure a desired recording/reproduction performance for a plurality of an information recording medium in a light source module with a simpler composition.

### SUMMARY OF THE INVENTION

An optical pickup apparatus according to the present invention includes: a first, a second and a third light emitting points for emitting light beams; an optical system for introducing the light beams emitted from the first, second and third emitting points to an objective lens; an objective lens for converging the light beams introduced by the optical system onto an information recording medium; and a light detector for detecting reflected light from the information recording medium, wherein a relationship of λ1<λ2<λ3 is satisfied, where λ1, λ2 and λ3 denote the respective wavelengths of the light beams emitted from the first, second and third light emitting points, and a relationship of either L1=L2<L3 or L1<L2=L3 or L1<L2<L3 is satisfied, where L1, L2 and L3 denote the respective distances between a reference axis which optically matches a center axis of the objective lens and the first, second and third light emitting points.

According to another aspect of the present invention, an optical pickup apparatus includes: a first, a second and a third light emitting points for emitting light beams; an optical system for introducing the light beams emitted from the first, second and third emitting points to an objective lens; an objective lens for converging the light beams introduced by the optical system onto an information recording medium; and a light detector for detecting reflected light from the information recording medium, wherein a relationship of P1<P2<P3 is satisfied, where P1, P2 and P3 denote the respective maximum outputs of the light beams emitted from the first, second and third light emitting points, and a relationship of either L1=L2<L3 or L1<L2=L3 or L1<L2<L3 is satisfied, whore L1, L2 and L3 denote the respective distances between a reference axis which optically matches a center axis of the objective lens and the first, second and third light emitting points.

According to the present invention, it is possible to increase the quality of light spots formed on optical discs from light beams emitted from three emitting points respectively. It is possible to realize a desired recording/reproduction performance for the optical discs having different formats.

The present invention is useful for improving the recording/reproduction performance of the optical pickup apparatus, simplifying a structure of the optical pickup apparatus and reducing the size and/or cost of the optical pickup apparatus, when the optical pickup apparatus is used to perform a recording operation or a reproduction operation for a plurality of optical discs having a plurality of different formats.

These and other advantages of the present invention will become apparent to those skilled in the art upon reading and understanding the following detailed description with reference to the accompanying Figures.

### BRIEF DESCRIPTION OF THE DRAWINGS

FIG. 1A is a diagram showing a structure of an optical pickup apparatus according to an embodiment of the present invention.

FIG. 1B is a diagram showing a structure of an optical system according to an embodiment of the present invention.

FIG. 2 is a diagram showing a structure of an optical pickup apparatus according to anther embodiment of the present invention.

FIG. 3 is a diagram showing a structure of an optical pickup apparatus according to another embodiment of the present invention.

FIG. 4 is a diagram showing a structure of a conventional optical pickup apparatus.

FIG. 5A is a diagram showing a structure of a light source module according to an embodiment of the present invention.

FIG. 5B is a diagram showing a structure of an optical pickup apparatus including the light source module shown in FIG. 5A.

FIG. 6 is a diagram showing a structure of a light source module according to anther embodiment of the present invention.

FIG. 7A is a diagram showing a structure of a light source module according to another embodiment of the present invention.

FIG. 7B is a diagram showing a structure of an optical pickup apparatus including the light source module shown in FIG. 7A.

FIG. 8A is a diagram showing a structure of a light source module according to another embodiment of the present invention.

FIG. 8B is a diagram showing a structure of an optical pickup apparatus including the light source module shown in FIG. 8A.

FIG. 9 is a diagram showing a structure of a conventional light source module.

FIG. 10 is a diagram showing a structure of an optical pickup apparatus including the conventional light source module shown in FIG. 9.

### DESCRIPTION OF THE PREFERRED EMBODIMENTS

### Embodiment 1

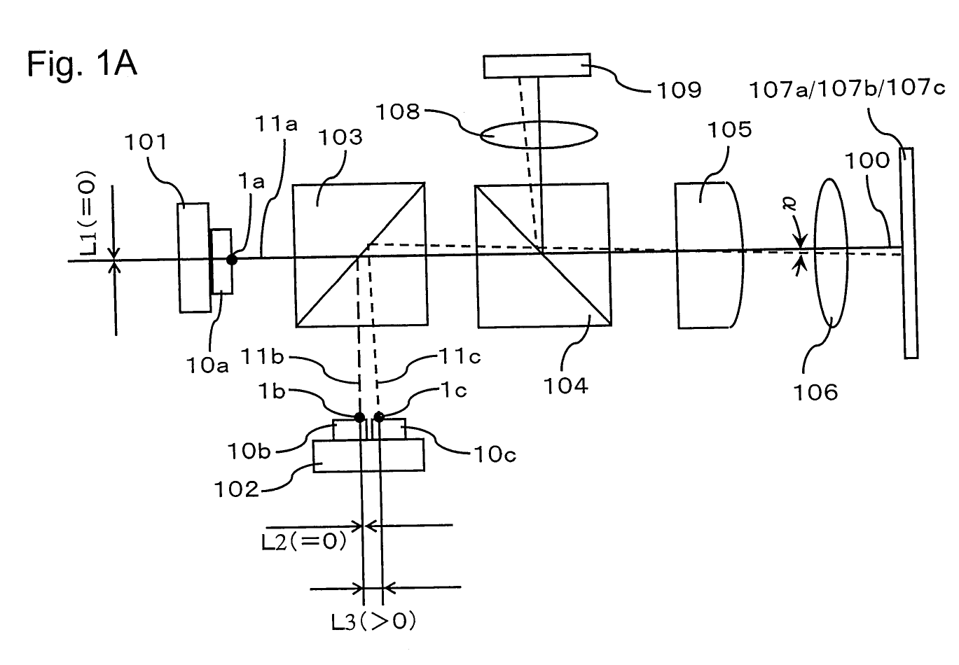

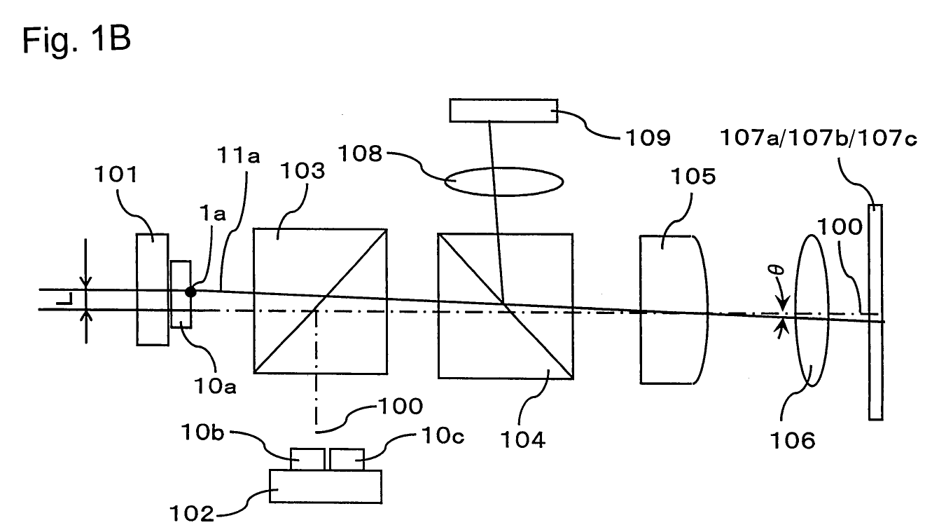

FIG. 1A shows a structure of an optical pickup apparatus according to an embodiment of the present invention.

A first laser light source 101 includes a semiconductor laser 10a for emitting a light beam 11a having a first wavelength λ1. A second laser light source 102 includes a semiconductor laser 10b for emitting a light beam 11b having a second wavelength λ2 and a semiconductor laser 10c for emitting a light beam 11c having a third wavelength λ3.

The first, second and third wavelengths λ1, λ2 and λ3 are different from each other, and a relationship of λ1<λ2<λ3 is satisfied.

The light beams 11a, 11b and 11c are emitted from light emitting points 1a, 1b and 1c of the semiconductor lasers 10a, 10b and 10c, respectively.

The light beams 11a, 11b, and 11c are used to perform a recording operation or a reproduction operation for a first optical disc 107a, a second optical disc 107b and a third optical disc 107c, respectively. The density of the format of the first optical disc is higher than that of the second optical disc. The density of the format of the second optical disc is higher than that of the third optical disc.

As shown in FIG. 1A, the light beam 11a of the first wavelength emitted from the semiconductor laser 10a of the first laser light source 101 is transmitted through beam-splitters 103 and 104 and is converted to a collimated light beam by a collimating lens 105. The light beam 11b of the second wavelength and the light beam 11c of the third wavelength emitted from the semiconductor lasers 10b and 10c of the second layer light source 102 are reflected by the beam-splitter 103, are transmitted through the beam-spitter 104 and are converted to collimated light beams by the collimating lens 105. The collimated light beams are converged onto the respective optical discs 107a, 107b and 107c by an objective lens 106 so as to form respective light spots on the respective optical discs 107a, 107b and 107c.

The reflected light beams from the respective optical discs are transmitted through the objective lens 106 and the collimating lens 105, are reflected by the beam-splitter 104, and converged onto a light detector 109 by a converging lens 108. As a result, the light detector 109 can detect various signals such as a tracking error signal and a focus error signal.

The detection of such various signals is easily realized based on the light beams incident on the light detector 109, for example, using a focus detecting method such as an astigmatism method or a tracking detecting method such as a push-pull method. Accordingly, the detailed description thereof are omitted with reference to FIG. 1A. However, the effect of the present invention described below is not limited by these detecting methods and the structure of the optical system.

In FIG. 1A, reference numeral 100 denotes the center axis of the objective lens 106. A reference axis which optically matches the center axis of the objective lens 106 is defined. In the present specification, the expression that it “optically matches an axis” should be interpreted to include a case where it matches the axis itself and a case where it matches the axis via an optical system. In the example shown in FIG. 1A, there are two reference axes. The first reference axis is along a direction from the first laser light source 101 to the objective lens 106. In FIG. 1A, the first reference axis is shown by a solid line indicating the light beam 11a, since the light beam 11a overlaps with the first reference axis. The second reference axis is along a direction from the second laser light source 102 through the beam-splitter 103 to the objective lens 106. In FIG. 1A, the second reference axle to shown by a broken line indicating the light beam 11b, since the light beam 11b overlaps with the second reference axis.

In general, as an optical disc for recording/reproduction has a format having a higher density, it is required to realize a higher quality of a light spot. The higher quality of the light spot can be realized, for example, by reducing aberrations of the light spot formed on the optical disc, using a semiconductor laser for emitting a light beam having a shorter wavelength and/or an objective lens having a higher numerical aperture.

Furthermore, the typical aberrations of the light spot is increased in inverse proportion to the wavelength of the light beam and is increased in proportion to the numerical aperture of the objective lens. Accordingly, it is required to realize further a higher and more accurate quality of the light spot.

In the optical pickup apparatus according to the present embodiment, it is required to minimize the aberrations of the light spot formed from the light beam 11a having the first wavelength, which is the shortest wavelength, for the first optical disc 107a, which has a format having the highest density, and to manage the quality of the light spot at the highest precision and the highest accuracy.

It is required to reduce the aberrations of the light spot formed from the light beam 11b having the second wavelength so as to improve the quality of the light spot, and then, it is required to reduce the aberrations of the light spot formed from the light beam 11c having the third wavelength so as to improve the quality of the light spot.

However, in the present embodiment, as shown in FIG. 1B, when there is a distance L between the light emitting point 1a of the semiconductor laser 10a mounted on the laser light source 101 and the center axis 100 of the objective lens 106, a light beam 11a passing through the light emitting point 1a of the semiconductor laser 10a and the principal point of the collimating lens 105 is incident on the objective lens 106 with a certain angle θ.

When the objective lens having a high numerical aperture is used to converge the light beam to form a light spot in the present embodiment, as the angle θ becomes larger, the aberrations of the light spot formed by converging the light beam onto the optical disc using the objective lens is increased so as to form a distorted light spot. As a result, the quality of the light spot and the recording/reproduction performance are degraded.

As described above, the amount of aberration of the light spot is increased as the light beam has a shorter wavelength. The light beams 11b and 11c, and their reflected light beams are not shown in FIG. 1B.

According to the present embodiment, the laser light sources 101 and 102 are configured after adjustment of two axes, such that, the light beam 11a passing through the light emitting point 1a of the semiconductor laser 10a mounted on the laser light source 101 and the principal point of the collimating lens 105 and the light beam 11b passing through the light emitting point 1b of the semiconductor laser 10b mounted on the laser light source 102 and the principal point of the collimating lens 105, are incident on the objective lens 106 with almost zero angle, respectively (i.e. such that the light emitting points 1a and 1b are located on the reference axis which optically matches the center axis 100 of the objective lens 106). Thus, the laser light sources 101 and 102 are configured to minimize the aberrations of the light spots formed from the light beams 11a and 11b and to optimize the quality of the light spots.

That is, the laser light sources 101 and 102 are configured to satisfy a relationship of L1=0, L2=0, L3≠0 and L1=L2<L3, where L1, L2 and L3 denote relative distances between the light emitting points 1a, 1b and 1c of the semiconductor lasers 10a, 10b and 10c and the reference axis which optically matches the center axis 100 of the objective lens 106, respectively.

In this case, the light emitting point 1c of the semiconductor laser 10c mounted on the second light source 102 is spaced apart from the light emitting point 1b of the semiconductor laser 10b mounted on the second light source 102. Since the relative distance L3 between the light emitting point 1c of the semiconductor laser 10c and the reference axis which optically matches the center axis 100 of the objective lens 106 is not equal to zero, the light beam 11c, passing through the light emitting point 1c of the semiconductor laser 10c and the principal point of the collimating lens 106, is incident on the objective lens 106 with a certain angle β. This causes an aberration of the light spot formed by converging the light beam 11c onto the optical disc 107c. Accordingly, the quality of the light spot is degraded compared to the quality of an ideal light spot obtained in the case where L3=0 (i.e. the light emitting point 1c of the semiconductor laser 10c is located on the reference axis which optically matches the center axis 100 of the objective lens 106) or β=0.

The optical disc 107c corresponding to the light beam 11c has a format having the lowest density, a tolerable range of the aberration of the light spot for realizing a desired recording/reproduction performance with respect to the optical disc 107c is relatively large. In the present embodiment, the angle β and the relative distance L3 are set such that the amount of the aberration of the light spot formed from the light beam 11c is within the tolerable range for realizing a desired recording/reproduction performance with respect to the optical disc 107c. Thus, an arrangement of the semiconductors lasers 10b and 10c mounted on the laser light source 102 (e.g. the distance between the light emitting points 1b and 1c) can be determined. Accordingly, it is possible to secure sufficiently high recording/reproduction performance with respect to the optical disc 107c.

Thus, according to the present embodiment, it is possible to realize a desired recording/reproduction performance with respect to the first, second and third optical discs having different formats, by optimally adjusting the laser light sources 101 and 102 to sufficiently reduce the aberrations of the light spots formed from the light beams 11a and 11b, which are required to be managed at the highest accuracy, such that the required recording/reproduction performance is realized for the first optical disc 107a and the second optical disc 107b having a format of higher density, and by setting the aberration of the light spot formed from the light beam 11c within a tolerable range for realizing the desired recording/reproduction performance.

According to the present embodiment, it is not necessary to provide any optical element for matching the optical axis of the light beam passing through the light emitting point and the principal point of the collimating lens with the center axis of the objective lens, even if a laser light source (e.g. the laser light source 102) having a plurality of light emitting points from which a plurality of light beams having different wavelengths are emitted is used. In addition, it is not necessary to adjust any parts associated with such an optical element.

Thus, a significant effect of providing an optical pickup apparatus which realizes a desired recording/reproduction performance with respect to three different optical discs can be obtained, wherein the optical pickup apparatus has a simple structure, a small size and a low cost.

Furthermore, according to the present embodiment, by using a laser light source (e.g. the laser light source 102) including a plurality of light emitting points from which a plurality of light beams having different wavelengths are emitted, it is possible to realize a recording/reproduction performance for three different optical discs with a simple structure having less parts and less portions required for adjustment. This is very useful to realize an optical pickup apparatus having a small size and a low cost.

In the present embodiment, it is described a case where two laser light sources (i.e. the first laser light source 101 and the second laser light source 102) are used. The first laser light source 101 including a light emitting point 1a from which a light beam having a first wavelength is emitted. The second laser light source 102 includes a light emitting point 1b from which a light beam having a second wavelength is emitted and a light emitting point 1c from which a light beam having a third wavelength is emitted.

Alternatively, the first laser light source 101 may include a light emitting point 1b from which a light beam having a second wavelength is emitted, and the second laser light source 102 may include a light emitting point 1a from which a light beam having a first wavelength is emitted and a light emitting point 1c from which a light beam having a third wavelength is emitted. In this case, an effect similar to the effect mentioned above can be obtained.

Specifically, in the present embodiment, the light emitting point 1c from which the light beam having the longest wavelength and one of the light emitting point 1a and the light emitting point 1b are integrated in a common package. By using a laser light source including the common package, it is possible to realize a recording/reproduction performance for three different optical discs with a simple structure described above. This is very useful to realize an optical pickup apparatus for performing a recording operation or reproduction operation for three different optical discs having three different formats, while it has a small size and a low cost.

In the present embodiment, it is described a case where the laser light source 102 includes two semiconductor lasers 10a and 10b, wherein each of the two semiconductor lasers 10a and 10b has a single light emitting point. Alternatively, a single semiconductor laser may include two light emitting points 1b and 1c. In this case, an effect similar to the effect mentioned above can be obtained. Thus, an arrangement of the laser light source according to the preset invention to not limited to that described in the present embodiment.

In addition, in the present embodiment, the laser light source 101 and/or the laser light source 102 may be configured to include a light detector for detecting reflected light from the optical disc corresponding to the light beam emitted from the light emitting point. In this case, the light source and the light detector may be integrated in a common package. It is possible to reduce the number of parts and the number of portions required for adjustment. This is very useful to realize an optical pickup apparatus for performing a recording operation or reproduction operation for three different optical discs having three different formats, while it has a small size and a low cost.

In the present invention, it is described a case where each light beam includes a single light beam. A light beam may be divided into a plurality of light beams using an optical element such as a hologram element. In this case, an effect similar to the effect mentioned above can be obtained, by applying the present invention to a main light beam among the plurality of light beams.

### Embodiment 2

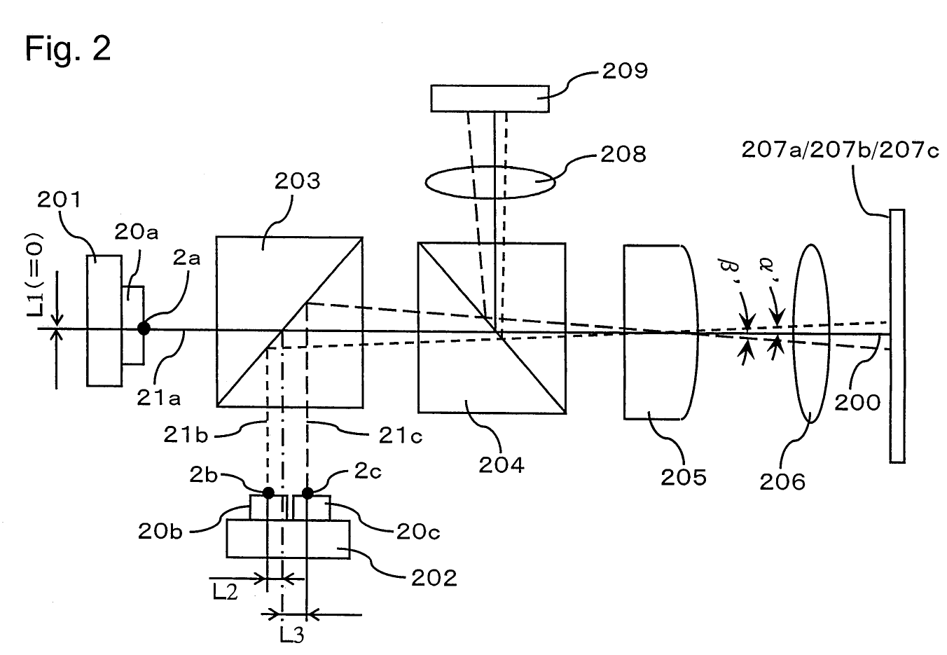

FIG. 2 shows a structure of an optical pickup apparatus according to another embodiment of the present invention.

A first laser light source 201 includes a semiconductor laser 20a for emitting a light beam 21a having a first wavelength λ1. A second laser light source 202 includes a semiconductor laser 20b for emitting a light beam 21b having a second wavelength λ2 and a semiconductor laser 20c for emitting a light beam 21c having a third wavelength λ3.

The first, second and third wavelengths λ1, λ2 and λ3 are different from each other, and a relationship of λ1<λ2<λ3 is satisfied.

The light beams 21a, 21b and 21c are emitted from light emitting points 2a, 2b and 2c of the semiconductor lasers 20a, 20b and 20c, respectively.

The light beams 21a, 21b and 21c are used to perform a recording operation or a reproduction operation for a first optical disc 207a, a second optical disc 207b and a third optical disc 207c, respectively. The density of the format of the first optical disc is higher than that of the second optical disc. The density of the format of the second optical disc is higher than that of the third optical disc.

As shown in FIG. 2, the light beam 21a of the first wavelength emitted from the semiconductor laser 20a of the first laser light source 201 is transmitted through the beam-splitters 203 and 204 and are converted to collimated light beams by a collimating lens 205. The light beam 21b of the second wavelength and the light beam 21c of the third wavelength emitted from the semiconductor lasers 20b and 20c of the second laser light source 202 are reflected by the beam splitter 203, are transmitted through the beam-splitter 204 and are converted to collimated light beams by the collimating lens 205. The collimated light beams are converged onto the respective optical discs 207a, 207b and 207c by an objective lens 206 so as to form the respective light spots on the respective optical discs 207a, 207b and 207c.

The reflected light beams from the respective optical discs are transmitted through the objective lens 206 and the collimating lens 205, are reflected by the beam-splitter 204, and converged onto a light detector 209 by a converging lens 208. As a result, the light detector 209 can detect various signals such as a tracking error signal and a focus error signal.

The detection of such various signals is easily realized based on the light beams incident on the light detector 209, for example, using a focus detecting method such as an astigmatism method or a tracking detecting method such as a push-pull method. Accordingly, the detailed description thereof are omitted with reference to FIG. 2. However, the effect of the present invention described below is not limited by these detecting methods and the structure of the optical system.

In FIG. 2, reference numeral 200 denotes the center axis of the objective lens 206. A reference axis which optically matches the center axis of the objective lens 206 is defined. In the example shown in FIG. 2, there are two reference axes. The first reference axis is along a direction from the first laser light source 201 to the objective lens 206. In FIG. 2, the first reference axis is shown by a solid line indicating the light beam 21a, since the light beam 21a overlaps with the first reference axis. The second reference axis is along a direction from the second laser light source 202 through the beam-splitter 203 to the objective lens 206. In FIG. 2, the second reference axis is shown by a dashed line.

As described above, as an optical disc for recording/reproduction has a format having a higher density, it is required to realize a higher quality of a light spot. The higher quality of the light spot can be realized, for example, by reducing aberrations of the light spot formed on the optical disc, using a semiconductor laser for emitting a light beam having a shorter wavelength and/or an objective lens having a higher numerical aperture.

Furthermore, the typical aberrations of the light spot is increased in inverse proportion to the wavelength of the light beam and is increased in proportion to the numerical aperture of the objective lens. Accordingly, it is required to realize further a higher and more accurate quality of the light spot.

In the optical pickup apparatus according to the present embodiment, it is required to minimize the aberrations of the light spot formed from the light beam 21a having the first wavelength, which is the shortest wavelength, for the first optical disc 207a, which has a format having the highest density, and to manage the quality of the light spot at the highest precision and the highest accuracy.

It is required to reduce the aberrations of the light spot formed from the light beam 21b having the second wavelength so as to improve the quality of the light spot, and then, it is required to reduce the aberrations of the light spot formed from the light beam 21c having the third wavelength so as to improve the quality of the light spot.

As described above, when there is a distance L′ between the light emitting point of the semiconductor laser and the reference axis which optically latches the center axis of the objective lens, a light beam passing through the light emitting point of the semiconductor laser and the principal point of the collimate lens is incident on the objective lens with a certain angle θ′

When the objective lens having a high numerical aperture to used to converge the light beam to form a light spot in the present embodiment, as the angle θ′ becomes larger, the aberrations of the light spot formed by converging the light beam onto the optical disc using the objective lens is increased so as to form a distorted light spot. As a result, the quality of the light spot and the recording/reproduction performance are degraded.

As described above, the amount of aberration of the light spot is increased as the light beam has a shorter wavelength.

According to the present embodiment, the laser light source 201 is configured after adjustment of two axes, such that the light beam 21a passing through the light emitting point 2a of the semiconductor laser 20a mounted on the laser light source 201 and the principal point of the collimating lens 205 is incident on the objective lens 206 with almost zero angle (i.e. such that the light emitting point 2a is located on the center axis 200 of the objective lens 206). Thus, the laser light source 201 is configured to minimize the aberrations of the light spot formed from the light beam 21a and to optimize the quality of the light spot.

Further, the second laser light source 202 is configured after adjustment of two axes, such that one of the light emitting point 2b of the semiconductor laser 20b and the light emitting point 2c of the semiconductor laser 20c is arranged on one side (e.g. a left side or a right side) of the reference axis which optically matches the center axis 200 of the objective lens 206, and such that the other of the light emitting point 2b of the semiconductor laser 20b, and the light emitting point 2c of the semiconductor laser 20c is arranged on the other side (e.g. a right side or a left aide) of the reference axle which optically matches the center axis 200 of the objective lens 206.

The second laser light source 202 is configured to satisfy a relationship of L2<L3, where L2 denotes a relative distance between the light emitting point 2b of the semiconductor laser 20b and the reference axis which optically matches the center axis 200 of the objective lens 206, and L3 denotes a relative distance between the light emitting point 2c of the semiconductor laser 20c and the center axis 200 of the objective lens 206

That is, the laser light sources 201 and 202 are configured to satisfy a relationship of L1=0, L2≠0, L3≠0 and L1=L2<L3, where L1 denotes a relative distance between the light emitting point 2a of the semiconductor laser 20a and the center axis 200 of the objective lens 206, L2 denotes a relative distance described above, and L3 denotes a relative distance described above.

In this case, the relative distance L2 between the light emitting point 2b of the semiconductor laser 20b and the reference axis which optically matches the center axis 200 of the objective lens 206 is not equal to zero. As a result, the light beam 21b, passing through the light emitting point 2b of the semiconductor laser 20b and the principal point of the collimating lens 206, is incident on the objective lens 206 with a certain angle α′. This causes an aberration of the light spot formed by converging the light beam 21b onto the optical disc 207b. Accordingly, the quality of the light spot is degraded compared to the quality of an ideal light spot obtained in the case where L2=0 (i.e. the light emitting point 2b of the semiconductor laser 20b is located on the reference axis which optically matches the center axis 200 of the objective lens 206) or α′=0.

In addition, the relative distance L3 between the light emitting point 2c of the semiconductor laser 20c and the reference axis which optically matches the center axis 200 of the objective lens 206 is not equal to zero. As a result, the light beam 21c, passing through the light emitting point 2c of the semiconductor laser 20c and the principal point of the collimating lens 206, is incident on the objective lens 206 with a certain angle β′. This causes an aberration of the light spot formed by converging the light beam 21b onto the optical disc 207b. Accordingly, the quality of the light spot is degraded compared to the quality of an ideal light spot obtained in the case where L3=0 (i.e. the light emitting point 2c of the semiconductor laser 20c is located on the reference axis which optically matches the center axis 200 of the objective lens 206) or β′=0.

Herein, it is considered a case where L2=0 (i.e. a case where the light emitting point 2b of the semiconductor laser 20b is located on the reference axis which optically matches the center axle 200 of the objective lens 206). In this case, it is possible to minimize the aberration of the light spot formed from the light beam 21b and to maximize the quality of the light spot for which the highest quality is required. In this case, the relative distance L3 between the light emitting point 2c of the semiconductor laser 20c and the reference axis which optically matches the center axis 200 of the objective lens 206 becomes relatively large, since the light emitting point 2b of the semiconductor laser 20b is spaced apart from the light emitting point 2c of the semiconductor laser 20c in the second laser light source 202. As a result, the aberration of the light spot formed from the light beam 21c is increased, thereby degrading the record/reproduction performance with respect to the optical disc 207c.

While the relationship of L2>0 is maintained, the distance between the light emitting point 2b of the semiconductor laser 20b and the light emitting point 2c of the semiconductor laser 20c, and the relative distances L2 and L3, are set such that the amount of the aberrations of the light spot formed from the light beam 21b is within a tolerable range for realizing a desired recording/reproduction performance with respect to the second optical disc 207b, and the amount of the aberrations of the light spot formed from the light beam 21c is within a tolerable range for realizing a desired recording/reproduction performance with respect to the third optical disc 207c. As a result, it is possible to realize a desired recording/reproduction performance with respect to the second and third optical discs 207b and 207c.

In the laser light source 202, by arranging the light emitting points 2b and 2c of the semiconductors lasers 20b and 20c at a certain distance on either side of the reference axis which optically matches the center axis 200 of the objective lens 206, it is possible to reduce the relative distances L2 and L3. As a result, it is possible to reduce the aberrations of the light spots formed from the light beams 21b and 21c.

Furthermore, for the reasons mentioned above, the relative distances L2 and L3 are set to satisfy a relationship of L2<L3. This is because it is required to reduce the aberration of the light spot formed from the light beam 21b and form the light spot having a higher quality so that the optical beam 21a passing through the light emitting point 2b of the semiconductor laser 20b and the principal point of the collimating lens 205 is incident on the objective lens with relatively small angle α′.

For the reasons mentioned above, it is possible to set such that the relative distance L2 is equal to the relative distance L3, when the recording/reproduction performance relative to the light spots formed from the light beams 21b and 21c is within a tolerable range for realizing a desired recording/reproduction performance.

Thus, according to the present embodiment, it is possible to realize a desired recording/reproduction performance with respect to the first, second and third optical discs having different formats, by optimally adjusting the laser light source to sufficiently reduce the aberrations of the light spot formed from the light beam 21a, which is required to be managed at the highest accuracy, such that the required recording/reproduction performance is realized for the first optical disc 207a having a format of the highest density, and by setting the aberrations of the light spots formed from the light beams 21b and 21c within a tolerable range for realizing the desired recording/reproduction performance.

According to the present embodiment, it is not necessary to provide any optical element for matching the optical axis of the light beam passing through the light emitting point and the principal point of the collimating lens with the center axis of the objective lens, even if a laser light source (e.g. the laser light source 202) having a plurality of light emitting points from which a plurality of light beams having different wavelengths are emitted is used. In addition, it is not necessary to adjust any parts associated with such an optical element.

Thus, a significant effect of providing an optical pickup apparatus which realizes a desired recording/reproduction performance with respect to three different optical discs can be obtained, wherein the optical pickup apparatus has a simple structure, a small size and a low cost.

In addition, as in the embodiment of the present invention, to realize a desired recording/reproduction performance for the third optical disc, when the tolerable range of the amount of aberrations tolerated at the light spot is small, it is necessary to make L3 smaller, this is highly effective.

Furthermore, according to the present embodiment, by using a laser light source (e.g. the laser light source 202) including a plurality of light emitting points from which a plurality of light beams having different wavelengths are emitted, it is possible to realize a recording/reproduction performance for three different optical discs with a simple structure having less parts and less portions required for adjustment. This is very useful to realize an optical pickup apparatus having a small size and a low cost.

In the present embodiment, it is described a case where the laser light source 202 includes two semiconductor lasers 20b and 20c, wherein each of the two semiconductor lasers 20b and 20c has a single light emitting point. Alternatively, a single semiconductor laser may include two light emitting points 2b and 2c. In this case, an effect similar to the effect mentioned above can be obtained. Thus, an arrangement of the laser light source according to the preset invention is not limited to that described in the present embodiment.

In addition, in the present embodiment, the laser light source 201 and/or the laser light source 202 may be configured to include a light detector for detecting reflected light from the optical disc corresponding to the light beam emitted from the light emitting point. In this case, the light source and the light detector may be integrated in a common package. It is possible to reduce the number of parts and the number of portions required for adjustment. This is very useful to realize an optical pickup apparatus for performing a recording operation or reproduction operation for three different optical discs having three different formats, while it has a small size and a low cost.

In the present invention, it is described a case where each light beam includes a single light beam. A light beam may be divided into a plurality of light beams using an optical element such as a hologram element. In this case, an effect similar to the effect mentioned above can be obtained, by applying the present invention to a main light beam among the plurality of light beams.

### Embodiment 3

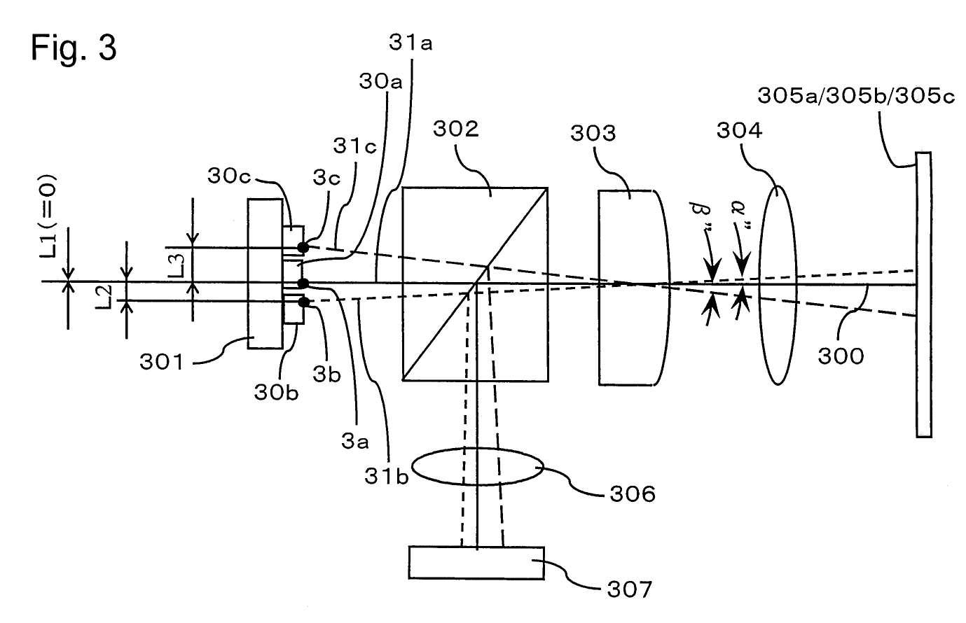

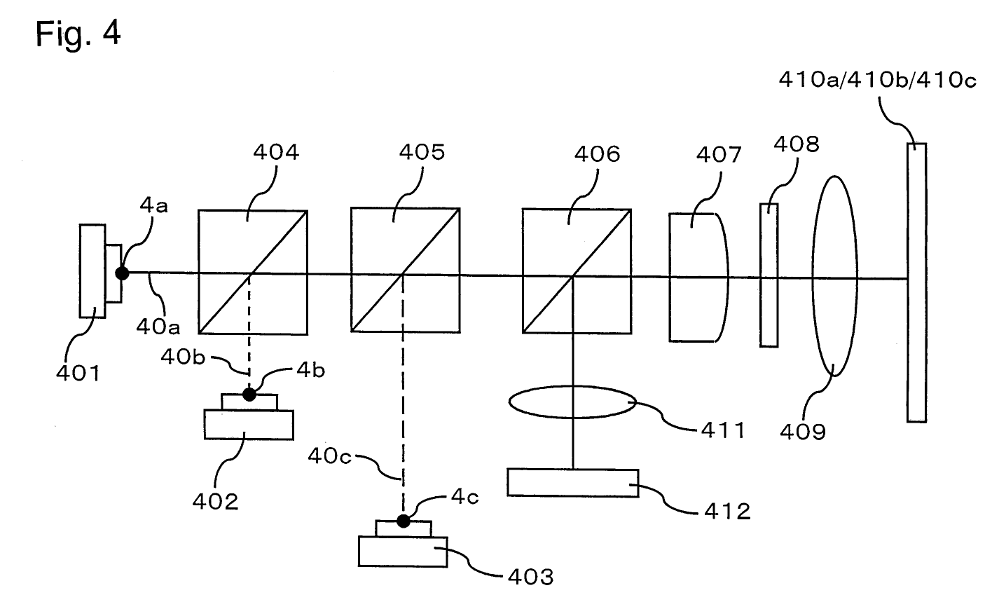

FIG. 3 shows a structure of an optical pickup system apparatus of another embodiment of the present invention.

A laser light source 301 includes a semiconductor laser 30a for emitting a light beam 31a having a first wavelength λ1, a semiconductor laser 30b for emitting a light beam 31b having a second wavelength λ2 and a semiconductor laser 30c for emitting a light beam 31c having a third wavelength λ3.

The first, second and third wavelengths λ1, λ2 and λ3 are different from each other, and a relationship of λ1<λ2<λ3 is satisfied.

The light beams 31a, 31b and 31c are emitted from light emitting points 3a, 3b and 3c of the semiconductor lasers 30a, 30b and 30c, respectively. The light emitting points 3a, 3b and 3c are integrated in a common package.

The light beams 31a, 31b and 31c are used to perform a recording operation or a reproduction operation for a first optical disc 305a, a second optical disc 305b and third optical disc 305c, respectively. The density of the format of the first optical disc is higher than that of the second optical disc. The density of the format of the second optical disc is higher than that of the third optical disc.

As shown in FIG. 3, the light beams 31a, 31b and 31c emitted from the laser light source 301, are transmitted through a beam-splitter 302, and are converted to collimated light beams by a collimating lens 303. The collimated light beams are converged onto the respective optical discs 305a, 305b and 305c by an objective lens 304 so as to form respective light spots on the respective optical discs 305a, 305b and 305c.

The reflected light beams from the respective optical discs are transmitted through the objective lens 304 and the collimating lens 303, are reflected by the beam-splitter 302, and converged onto a light detector 307 by a converging lens 306. As a result, the light detector 307 can detect various signals such as a tracking error signal and a focus error signal.

The detection of such various signals is easily realized based on the light beams entered into the light detector 307, for example, using a focus detecting method such as an astigmatism method or a tracking detecting method such as a push-pull method. Accordingly, the detailed description thereof are omitted with reference to FIG. 3. However, the effect of the present invention described below is not limited by these detecting methods and the structure of the optical system.

In FIG. 3, reference numeral 300 is the center axis of the objective lens 304. In the example shown in FIG. 3, the reference axis which optically matches the center axis of the objective lens overlaps with the light beam 31a and is shown by a solid line.

As described above, as an optical disc for recording/reproduction has a format having a higher density, it is required to realize a higher quality of a light spot. The higher quality of the light spot can be realized, for example, by reducing aberrations of the light spot formed on the optical disc, using a semiconductor laser for emitting a light beam having a shorter wavelength and/or an objective lens having a higher numerical aperture.

In the optical pickup apparatus according to the present embodiment, it is required to minimize the aberrations of the light spot formed from the light beam 31a having the first wavelength, which is the shortest wavelength, for the first optical disc 305a, which has a format having the highest density, and to manage the quality of the light spot at the highest precision and the highest accuracy.

It is required to reduce the aberrations of the light spot formed from the light beam 31b having the second wavelength so as to improve the quality of the light spot, and then, it is required to reduce the aberrations of the light spot formed from the light beam 31c having the third wavelength so as to improve the quality of the light spot.

As described above, there is a distance L″ between the light emitting point and the center axis of the objective lens (or the reference axis which optically matches the center axis of the objective lens), a light beam passing through the light emitting point of the semiconductor laser and the principal point of the collimating lens is incident on the objective lens with a certain angle θ″.

When the objective lens having a high numerical aperture is used to converge the light beam to form a light spot in the present embodiment, as the angle θ″ becomes larger, the aberrations of the light spot formed by converging the light beam onto the optical disc using the objective lens is increased so as to form a distorted light spot. As a result, the quality of the light spot and the recording/reproduction performance are degraded.

As described above, the amount of aberration of the light spot is increased as the light beam has a shorter wavelength.

According to the present embodiment, the laser light source 301 is configured after adjustment of two axes, such that the light beam 31a passing through the light emitting point 3a of the semiconductor laser 30a mounted on the laser light source 301 and the principal point of the collimating lens 303 is incident on the objective lens 304 with almost zero angle (i.e. such that the light emitting point 3a is located on the center axis 300 of the objective lens 304). Thus, the laser light source 301 is configured to minimize the aberrations of the light spot formed from the light beam 31a and to optimize the quality of the light spot.

Further, the laser light source 301 is configured such that one of the light emitting point 3b of the semiconductor laser 30b and the light emitting point 3c of the semiconductor laser 30c is arranged on one side (e.g. a left side or a right side) of the reference axis which optically matches the center axis 300 of the objective lens 304, and such that the other of the light emitting point 3b of the semiconductor laser 30b, and the light emitting point 3c of the semiconductor laser 30c is arranged on the other side (e.g. a right side or a left side) of the reference axis which optically matches the center axle 300 of the objective lens 304.

The laser light source 301 is configured to satisfy a relationship of L2<L3, where L2 denotes a relative distance between the light emitting point 3b of the semiconductor laser 30b and the reference axis which optically matches the center axis 300 of the objective lens 304, and L3 denotes a relative distance between the light emitting point 3c of the semiconductor laser 30c and the center axis 300 of the objective lens 304.

That is, the laser light source 301 is configured to satisfy a relationship of L1=0, L2≠0, L3≠0 and L1<L2<L3, where L1 denotes a relative distance between the light emitting point 3a of the semiconductor laser 30a and the center axis 300 of the objective lens 304, L2 denotes a relative distance described above, and L3 denotes a relative distance described above.

In this case, the relative distance L2 between the light emitting point 3b of the semiconductor laser 30b and the reference axis which optically matches the center axis 300 of the objective lens 304 is not equal to zero. As a result, the light beam 31b, passing through the light emitting point 3b of the semiconductor laser 30b and the principal point of the collimating lens 303, is incident on the objective lens 304 with a certain angle α″. This causes an aberration of the light spot formed by converging the light beam 31b onto the optical disc 305b. Accordingly, the quality of the light spot is degraded compared to the quality of an ideal light spot obtained in the case where L2=0 (i.e. the light emitting point 3b of the semiconductor laser 30b is located on the reference axis which optically matches the center axis 300 of the objective lens 304) or α″=0.

In addition, the relative distance L3 between the light emitting point 3c of the semiconductor laser 30c and the reference axis which optically matches the center axis 300 of the objective lens 304 is not equal to zero. As a result, the light beam 31c, passing through the light emitting point 2c of the semiconductor laser 30c and the principal point of the collimating lens 303, is incident on the objective lens 304 with a certain angle β″. This causes an aberration of the light spot formed by converging the light beam 21b onto the optical disc 305b. Accordingly, the quality of the light spot to degraded compared to the quality of an ideal light spot obtained in the case where L3=0 (i.e. the light emitting point 2c of the semiconductor laser 30c is located on the reference axis which optically matches the center axis 300 of the objective lens 304) or β″=0.

For the reasons mentioned above, it is required to reduce the aberrations of the light spot formed from the light beam 31b so that the quality of the light spot is increased. In order to do so, it is necessary to reduce the relative distance L2 such that the angle α″ is reduced and to reduce the relative distance L3 such that the angle β″ is reduced, while the relationship of L2<L3 is maintained.

The distance between the light emitting point 3b of the semiconductor laser 30b and the light emitting point 3c of the semiconductor laser 30c, and the relative distances L2 and L3, are set such that the amount of the aberrations of the light spot formed from the light beam 31b is within a tolerable range for realizing a desired recording/reproduction performance with respect to the second optical disc 305b, and the amount of the aberrations of the light spot formed from the light beam 31c to within a tolerable range for realizing a desired recording/reproduction performance with respect to the third optical disc 305c. As a result, it is possible to realize a desired recording/reproduction performance with respect to the second and third optical discs 305b and 305c.

In the laser light source 301, by having an arrangement of the light emitting points 3b and 3c of the two semiconductors lasers 30b and 30c arranged a certain distance on either side of the center axis 300 of the objective lens 304, it is possible to reduce L2 and L3. As a result, it is possible to reduce the aberration of the light spot formed from the light beams 31b and 31c.

Thus, according to the present embodiment, it is possible to realize a desired recording/reproduction performance with respect to the first, second and third optical discs having different formats, by optimally adjusting the laser light source 301 to sufficiently reduce the aberrations of the light spot formed from the light beam 31a, which is required to be managed at the highest accuracy, such that the required recording/reproduction performance is realized for the first optical disc 305a having a format of the highest density, and by setting the aberrations of the light spots formed from the light beams 31b and 31c within a tolerable range for realizing the desired recording/reproduction performance.

According to the present embodiment, it is not necessary to provide any optical element for matching the optical axis of the light beam passing through the light emitting point and the principal point of the collimating lens with the center axis of the objective lens, even if it is used as a light source module such as the light source module 1301 having a plurality of light emitting points which emit a plurality of light beams having different wavelengths. In addition, it is not necessary to adjust any parts associated with such an optical element.

Thus, a significant effect of providing an optical pickup apparatus which realizes a desired recording/reproduction performance with respect to three different optical discs can be obtained, wherein the optical pickup apparatus has a simple structure, a small size and a low cost.

In the present embodiment, it is described a case where the laser light source 301 includes three semiconductor lasers 30a, 30b and 30c, wherein each of the three semiconductor lasers 30a, 30b and 30c has a single light emitting point. Alternatively, the laser light source 301 may include a single semiconductor laser having three light emitting points from which three light beams having different wavelengths are emitted. Alternatively, the laser light source 301 may include a semiconductor laser having two light emitting points and a semiconductor laser having one light emitting point. In this case, an effect similar to the effect mentioned above can be obtained. Thus, an arrangement of the laser light source according to the preset invention is not limited to that described in the present embodiment.

In addition, in the present embodiment, the laser light source 301 may be configured to include a light detector for detecting reflected light from the optical disc corresponding to the light beam emitted from the light emitting point. In this case, the light source and the light detector may be integrated in a common package. It is possible to reduce the number of parts and the number of portions required for adjustment. This is very useful to realize an optical pickup apparatus for performing a recording operation or reproduction operation for three different optical discs having three different formats, while it has a small size and a low cost.

In the present invention, it is described a case where each light beam includes a single light beam. A light beam may be divided into a plurality of light beams using an optical element such as a hologram element. In this case, an effect similar to the effect mentioned above can be obtained, by applying the present invention to a main light beam among the plurality of light beams.

### Embodiment 4

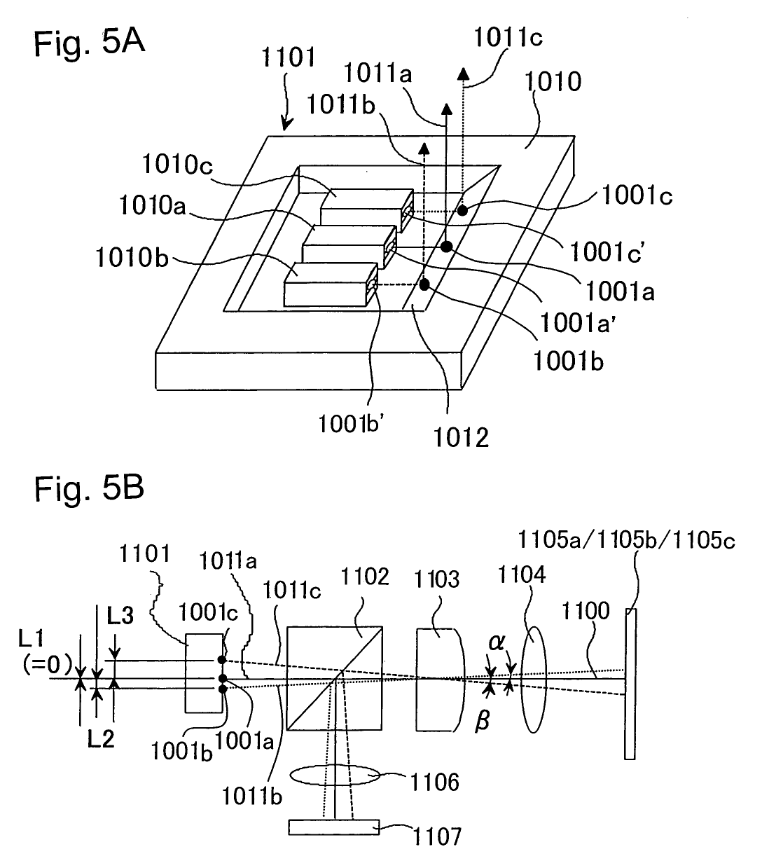

FIG. 5A shows a structure of a light source module used in an optical pickup apparatus according to an embodiment of the present invention. FIG. 5B shows a structure of an optical system using the light source module.

As shown in FIG. 5A, a light source module 1101 includes a semiconductor laser 1010a for emitting a light beam 1011a having a first wavelength λ1, a semiconductor laser 1010b for emitting a light beam 1011b having a second wavelength λ2 and a semiconductor laser 1010c for emitting a light beam 1011c having a third wavelength λ3.

The first, second and third wavelengths λ1, λ2 and λ3 are different from each other, and a relationship of λ1<λ2<λ3 is satisfied.

The semiconductor lasers 1010a, 1010b and 1010c are mounted on a common substrate 1010 and are arranged to be in parallel.

The light beams 1011a, 1011b and 1011c are emitted from light emitting points 1001a′ 1001b′ and 1001c′ of the semiconductor lasers 1010a, 1010b and 1010c, respectively, and are reflected by a reflective surface 1012 provided on the common substrate 1010. As a result, the light beams 1011a, 1011b and 1011c are emitted in a direction perpendicular to the common substrate 1010 from light emitting points 1001a, 1001b and 1001c which are equivalent to the light emitting points 1001a′ 1001b′ and 1001c′. Hereinafter, the equivalent light emitting points 1001a, 1001b and 1001c are treated as light emitting points of the light source module 1101.

The light beams 1101a, 1001b and 1101c are used to perform a recording operation or a reproduction operation for a first optical disc 1105a, a second optical disc 1105b and a third optical disc 1105a, respectively. The first, second and third optical discs have a format for the higher density, in this order.

As shown in FIG. 5B, the light beams 1011a, 1011b and 1011c emitted from the light source module 1101 are transmitted through a beam-splitter 1102 and are converted to collimated light beams by a collimating lens 303. The collimated light beams are converged onto the respective optical discs 1105a, 1105b and 1105c by an objective lens 304 so as to form the respective light spots on the respective optical discs 1105a, 1105b and 1105c.

The objective lens 1104 may include a plurality of components each depending on the wavelength of the light beam or may be a single component which converges a plurality of light beams having different wavelengths onto the optical discs.

The reflected light beams reflected from the respective optical discs are transmitted through the objective lens 1104 and the collimating lens 1103, are reflected by the beam-splitter 1102, and converged on a light detector 1107 by a converging lens 1106. As a result, the light detector 1107 can detect various signals such as a tracking error signal and a focus error signal.

The detection of such various signals is easily realized based on the light beams entered into the light detector 1107, for example, using a focus detecting method such as an astigmatism method or a tracking detecting method such as a push-pull method. Accordingly, the detailed description thereof are omitted with reference to FIGS. 5A and 5B. However, the effect of the present invention described below is not limited by these detecting methods and the structure of the optical system.

In FIG. 5B, reference numeral 1100 denotes a center axis of the objective lens 1104. In the example shown in FIG. 5B, a reference axis which optically matches the center axis of the objective lens 1104 is indicated by a solid line, since the reference axis overlaps with the light beam 1101a.

In general, as an optical disc for recording/reproduction has a format having a higher density, it is required to realize a higher quality of a light spot. The higher quality of the light spot can be realized, for example, by reducing aberrations of the light spot formed on the optical disc, using a semiconductor laser for emitting a light beam having a shorter wavelength and/or an objective lens having a higher numerical aperture.

Furthermore, the typical aberrations of the light spot is increased in inverse proportion to the wavelength of the light beam and is increased in proportion to the numerical aperture of the objective lens. Accordingly, it is required to realize further a higher and more accurate quality of the light spot.

In the optical pickup apparatus according to the present embodiment, it is required to minimize the aberrations of the light spot formed from the light beam 1011a having the first wavelength, which is the shortest wavelength, for the first optical disc 1105a, which has a format having the highest density, and to manage the quality of the light spot at the highest precision and the highest accuracy.

It is required to reduce the aberrations of the light spot formed from the light beam 1011b having the second wavelength so as to improve the quality of the light spot, and then, it is required to reduce the aberrations of the light spot formed from the light beam 1011c having the third wavelength so as to improve the quality of the light spot.

As described above, when there is a distance L between the light emitting point of the semiconductor laser and the center axis of the objective lens (or the reference axis which optically matches the center axis of the objective lens), a light beam passing through the light emitting point of the semiconductor laser and the principal point of the collimating lens is incident on the objective lens with a certain angle θ.

When the objective lens having a high numerical aperture is used to converge the light beams to form a light spot in the present embodiment, as the angle θ becomes larger, the aberrations of the light spot formed by converging the light beam onto the optical disc using the objective lens is increased so as to form a distorted light spot. As a result, the quality of the light spot and the recording/reproduction performance are degraded.

As described above, the amount of aberration of the light spot is increased as the light beam has a shorter wavelength.

According to the present embodiment, the light source module 1101 is configured after adjustment of two axes, such that, the light beam 1011a passing through the light emitting point 1001a of the semiconductor laser 1010a and the principal point of the collimating lens 1103, is incident on the objective lens 1104 with almost zero angle (i.e. such that the light emitting point 1001a is located an the center axis 1110 of the objective lens 1104). Thus, the light source module 1101 can be configured to minimize the aberrations of the light spot formed from the light beam 1011a and to optimize the quality of the light spot.

Further, the light source module 1101 is configured such that one of the light emitting point 1001b of the semiconductor laser 1010b and the light emitting point 1001c of the semiconductor laser 1010c is arranged on one side (e.g. a left side or a right side) of the center axis 1100 of the objective lens 1004, and the other of the light emitting point 1001b of the semiconductor laser 1010b, and the light emitting point 1001c of the semiconductor laser 1010c is arranged on the other side (e.g. a right side or a left side) of the center axis 1100 of the objective lens 1004.

The light source module 1101 is configured to satisfy a relationship of L2<L3, where L2 denotes a relative distance between the light emitting point 1001b of the semiconductor 1010b and the center axis 1100 of the objective lens 1104, and L3 denotes a relative distance between the light emitting point 1001c of the semiconductor 1010c and the center axis 1100 of the objective lens 1104

That is, the light source module 1101 is configured to satisfy a relationship of L1=0, L2≠0, L3≠0 and L1<L2<L3, where L1 denotes a relative distance between the light emitting point 1001a of the semiconductor 1010a and the center axis 1100 of the objective lens 1104, L2 denotes a relative distance described above, and L3 denotes a relative distance described above.

In this case, because of L2≠0, the light beam 1011b, passing through the light emitting point 1001b of the semiconductor laser 1010b and the principal point of the collimating lens 1103, is incident on the objective lens 1104 with a certain angle α. This causes an aberration of the light spot formed by converging the light beam 1011b onto the second optical disc 1105b. Similarly, because of L3≠0, the light beam 1011c, passing through the light emitting point 1001c of the semiconductor laser 1010c and the principal point of the collimating lens 1103, is incident on the objective lens 1104 with a certain angle β. This causes an aberration of the light spot formed by converging the light beam 1011c onto the third optical disc 1105c. Accordingly, the quality of these light spots are degraded compared to the quality of an ideal light spot obtained in the case where L2=L3=0 (i.e. the light emitting points 1001b and 1001c are located on the center axis 1110 of the objective lens 1104 such that the angles α and β are equal to zero).

For the reasons mentioned above, it is required to reduce the aberration of the light spot formed from the light beam 1011b so that the quality of the light spot is increased. In order to do so, it is necessary to reduce the relative distance L2 such that the angle α is reduced and to reduce the relative distance L3 such that the angle β is reduced, while the relationship of L2<L3 is maintained.

The distance between the light emitting point 1001b of the semiconductor laser 1010b and the light emitting point 1001c of the semiconductor laser 1010c, and the relative distances L2 and L3, are set such that the amount of the aberrations of the light spot formed from the light beam 1011b is within a tolerable range for realizing a desired recording/reproduction performance with respect to the second optical disc 1105b, and the amount of the aberrations of the light spot formed from the light beam 1011c is within a tolerable range for realizing a desired recording/reproduction performance with respect to the third optical disc 1105c. As a result, it is possible to realize a desired recording/reproduction performance with respect to the second and third optical discs 1105b and 1105c.

By arranging one of the light emitting point 1001b of the semiconductor laser 1010b and the light emitting point 1001c of the semiconductor laser 1010c on one side (e.g. a left side or a right side) of the center axis 1100 of the objective lens 1004, and arranging the other of the light emitting point 1001b of the semiconductor laser 1010b and the light emitting point 1001c of the semiconductor laser 1010c on the other side (e.g. a right side or a left side) of the center axle 1100 of the objective lens 1004, it is possible to reduce the relative distances L2 and L3. This makes it possible to reduce the aberrations of the light spots formed from the light beams 1011b and 1011c. Further, it is possible to set such that the relative distance L2 is equal to the relative distance L3, when the recording/reproduction performance relative to the light spots formed from the light beams 1011b and 1011c is within a tolerable range for realizing a desired recording/reproduction performance.

Thus, according to the present embodiment, it is possible to realize a desired recording/reproduction performance with respect to the first, second and third optical discs having different formats, by optimally adjusting the light source module 1101c to sufficiently reduce the aberrations of the light spot formed from the light beam 1011a, which is required to be managed at the highest accuracy, such that the required recording/reproduction performance is realized for the first optical disc 1105a having a format of the highest density, and by setting the aberrations of the light spots formed from the light beams 1011b and 1011c within a tolerable range for realizing the desired recording/reproduction performance.

According to the present embodiment, it is not necessary to provide any optical element for matching the optical axis of the light beam passing through the light emitting point and the principal point of the collimating lens with the center axis of the objective lens, even if it is used as a light source module such as the light source module 1101 having a plurality of light emitting points which emit a plurality of light beams having different wavelengths. In addition, it is not necessary to adjust any parts associated with such an optical element.

Thus, a significant effect of providing an optical pickup apparatus which realizes a desired recording/reproduction performance with respect to three different optical discs can be obtained, wherein the optical pickup apparatus has a simple structure, a small size and a low cost.

In the present embodiment, it is described a case where the light source module 1101 includes three semiconductor lasers, each of the three semiconductor lasers includes a single light emitting point, and the three semiconductor lasers emit the light beams 1101a, 1101b and 1101c having different wavelengths, respectively.

Alternatively, the light source module 1101 may include a single monolithic semiconductor laser for emitting three light beams having different wavelengths from three light emitting points.

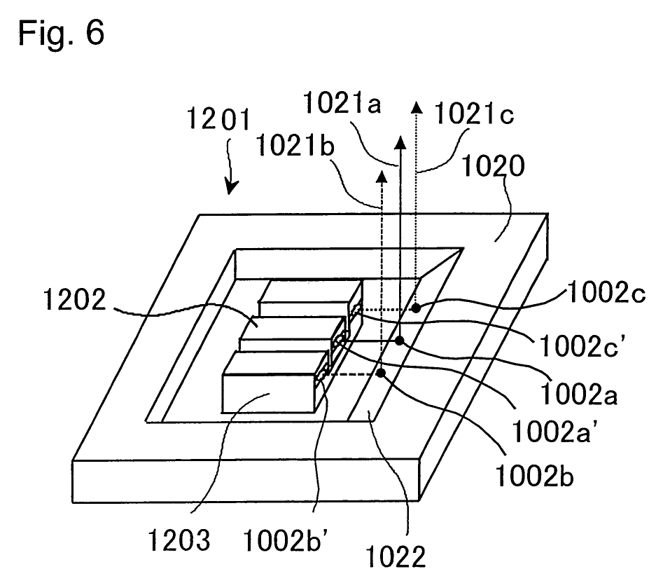

Alternatively, as shown in FIG. 6, the light source module 1101 may include a semiconductor laser 1202 for emitting a light beam 1201a having a first wavelength from a first light emitting point 1002a and a monolithic semiconductor laser for emitting a light beam 1202b having a second wavelength from a second light emitting point 1002b and for emitting a light beam 1202c having a third wavelength from a third light emitting point 1002c.

In these alternative cases, it is possible to reduce the number of semiconductor lasers mounted on the light source module by using a semiconductor laser for emitting two or three light beams. As a result, it is possible to simplify or omit some procedure such as an adjustment procedure of adjusting the position of the semiconductor lasers in producing the light source module, thereby reducing the cost of the light source module. In this case, an effect similar to the effect mentioned above can be obtained, by optimally adjusting the light source module such that the aberrations of the light spots formed from the light beam having the shortest wavelength among the three light beams is sufficiently reduced.

In the present invention, it is described a case where each light beam includes a single light beam. A light beam may be divided into a plurality of light beams using an optical element such as a hologram element. In this case, an effect similar to the effect mentioned above can be obtained, by applying the present invention to a main light beam among the plurality of light beams.

### Embodiment 5

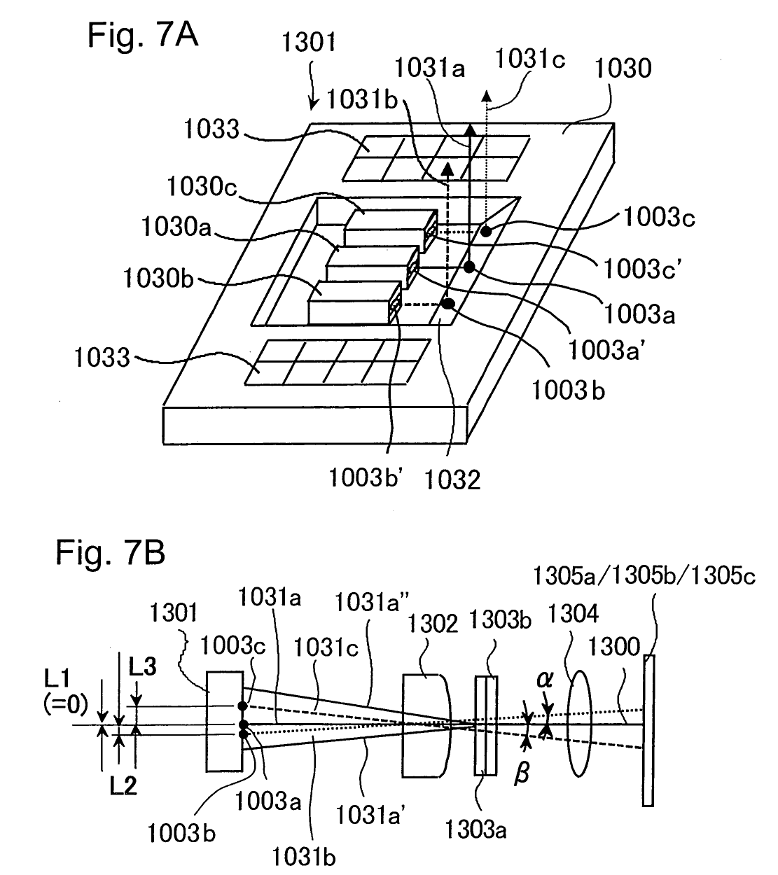

FIG. 7A shows another structure of a light source module used in an optical pickup apparatus according to an embodiment of the present invention. FIG. 7B shows another structure of an optical system using the light source module.

As shown in FIG. 7A, a light source module 1301 includes a semiconductor laser 1030a for emitting a light beam 1031a having a first wavelength λ1, a semiconductor laser 1030b for emitting a light beam 1031b having a second wavelength λ2 and a semiconductor laser 1030c for emitting a light beam 1031c having a third wavelength λ3.

The first, second and third wavelengths λ1, λ2 and λ3 are different from each other, and a relationship of λ1<λ2<λ3 is satisfied.

The semiconductor lasers 1030a, 1030b and 1030c are mounted on a common substrate 1030 and are arranged to be in parallel.

The light beams 1031a, 1031b and 1031c are emitted from light emitting points 1003a′ 1003b′ and 1003c′ of the semiconductor lasers 1030a, 1030b and 1030c, respectively, and are reflected by a reflective surface 1032 provided on the common substrate 1030. As a result, the light beams 1031a, 1031b and 1031c are emitted in a direction perpendicular to the common substrate 1030 from light emitting points 1003a, 1003b and 1003c which are equivalent to the light emitting points 1003a′ 1003b′ and 1003c′.

The light beams 1031a, 1031b and 1031c are used to perform a recording operation or a reproduction operation for a first optical disc 1305a, a second optical disc 1305b and a third optical disc 1305c, respectively. On the substrate 1030, the light detector 1033, which is divided into a plurality of portions, is integrated. The first, second and third optical discs have a format for the higher density, in this order.

As shown in FIG. 7B, the first light beam 1031a or the second light beam 1031b emitted from the light source module 1301 and is transmitted through a collimating lens 1302 and is incident on a polarization hologram 1303a. A polarization hologram 1303a is integrated with a ¼ wavelength plate 1303b. The polarization hologram 1303a has a diffraction grating which transmits the light beam with respect to the polarization direction of the light beam and diffracts and converges the light beam with respect to the polarization direction perpendicular to the direction of the light beam. The light beam is transmitted through the polarization hologram 1303a and is converted into circularly polarized light by the ¼ wavelength plate 1303b. The circularly polarized light is converged onto the respective optical discs 1305a, 1305b and 1305c by the objective lens 1304.

The light beams reflected by the optical discs 1305a, 1305b and 1305c are transmitted through the objective lens 1304 and are converted from circularly polarized light into linearly polarized light beams by the ¼ wavelength plate 1303b. The light beams from the ¼ wavelength plate 1303b are diffracted and converged onto the light detector 1033 by the polarization hologram 1303a. As a result, the light detector 1033 can detect various signals such as a tracking error signal and a focus error signal.

The detection of such various signals to easily realized based on the light beams entering into the light detector 1033, for example, using a focus detecting method such as a spot size detection (SSD) method or a tracking detecting method such as a push-pull method. Accordingly, the detailed descriptions thereof are omitted with reference to FIGS. 7A and 7B. However, the effect of the present invention described below is not limited by these detecting methods and the structure of the optical system.

In FIG. 7B, reference numeral 1300 denotes a center axis of the objective lens 1304. In the example shown in FIG. 7B, a reference axis which optically matches the center axis of the objective lens 1304 is indicated by a solid line, since the reference axis overlaps with the light beam 1301a.

As mentioned above, in the optical pickup apparatus according to the present embodiment, it is required to minimize the aberrations of the light spot formed from the light beam 1031a having the first wavelength, which is the shortest wavelength, for the first optical disc 1305a, which has a format having the highest density, and to manage the quality of the light spot at the highest precision and the highest accuracy.

It is required to reduce the aberrations of the light spot formed from the light beam 1031b having the second wavelength so as to improve the quality of the light spot, and then, it is required to reduce the aberrations of the light spot formed from the light beam 1031c having the third wavelength so as to improve the quality of the light spot.

When there is a distance L between the light emitting point of the semiconductor laser and the center axis 1300 of the objective lens 1304 (or the reference axis which optically matches the center axis 1300 of the objective lens 1304), a light beam passing through the light emitting point of the semiconductor laser and the principal point of the collimating lens 1302 is incident on the objective lens with a certain angle θ.

When the objective lens having a high numerical aperture is used to converge the light beams to form a light spot in the present embodiment, as the angle θ becomes larger, the aberrations of the light spot formed by converging the light beam onto the optical disc using the objective lens as increased so as to form a distorted light spot. As a result, the quality of the light spot and the recording/reproduction performance are degraded.

As described above, the amount of aberration of the light spot is increased as the light beam has a shorter wavelength.

According to the present embodiment, the light source module 1301 is configured after adjustment of two axes, such that, the light beam 1031a passing through the light emitting point 3a of the semiconductor laser 1030a and the principal point of the collimating lens 1303, is incident on the objective lens 1304 with almost zero angle (i.e. such that the light emitting point 1003a is located on the center axis 1300 of the objective lens 1304). Thus, the light source module 1301 can be configured to minimize the aberrations of the light spot formed from the light beam 1031a and to optimize the quality of the light spot.

Further, the light source module 1301 is configured such that one of the light emitting point 1003b of the semiconductor laser 1030b and the light emitting point 1003c of the semiconductor laser 1030c is arranged on one side (e.g. a left side or a right side) of the center axis 1300 of the objective lens 1304, and the other of the light emitting point 1003b of the semiconductor laser 1030b, and the light emitting point 1003c of the semiconductor laser 1030c is arranged on the other side (e.g. a right side or a left side) of the center axis 1300 of the objective lens 1304.

The light source module 1301 is configured to satisfy a relationship of L2<L3, where L2 denotes a relative distance between the light emitting point 1003b of the semiconductor laser 1030b and the center axis 1300 of the objective lens 1304, and L3 denotes a relative distance between the light emitting point 1003c of the semiconductor laser 1030c and the center axis 1300 of the objective lens 1304

That is, the light source module 1301 is configured to satisfy a relationship of L1=0, L2≠0, L3≠0 and L1<L2<L3, where L1 denotes a relative distance between the light emitting point 1003a of the semiconductor laser 1030a and the center axis 1300 of the objective lens 1304, L2 denotes a relative distance described above, and L3 denotes a relative distance described above.

In this case, because of L2≠0, the light beam 1031b, passing through the light emitting point 1003b of the semiconductor laser 1030b and the principal point of the collimating lens 1303, is incident on the objective lens 1304 with a certain angle α. This causes an aberration of the light spot formed by converging the light beam 1031b onto the second optical disc 1305b. Similarly, because of L3≠0, the light beam 1031c, passing through the light emitting point 1003c of the semiconductor laser 1030c and the principal point of the collimating lens 1303, is incident on the objective lens 1304 with a certain angle β. This causes an aberration of the light spot formed by converging the light beam 1031c onto the third optical disc 1305c. Accordingly, the quality of these light spots are degraded compared to the quality of an ideal light spot obtained in the case where L2=L3=0 (i.e. the light emitting points 1003b and 1003c are located on the center axis 1300 of the objective lens 1304 such that the angles α and β are equal to zero).

For the reasons mentioned above, it is required to reduce the aberrations of the light spot formed from the light beam 1031b so that the quality of the light spot is increased. In order to do so, it is necessary to reduce the relative distance L2 such that the angle α is reduced and to reduce the relative distance L3 such that the angle β is reduced, while the relationship of L2<L3 is maintained.

The distance between the light emitting point 1003b of the semiconductor laser 1030b and the light emitting point 1003c of the semiconductor laser 1030c, and the relative distances L2 and L3, are set such that the amount of the aberrations of the light spot formed from the light beam 1031b is within a tolerable range for realizing a desired recording/reproduction performance with respect to the second optical disc 1305b, and the amount of the aberrations of the light spot formed from the light beam 1031c is within a tolerable range for realizing a desired recording/reproduction performance with respect to the third optical disc 1305c. As a result, it is possible to realize a desired recording/reproduction performance with respect to the second and third optical discs 1305b and 1305c.

By arranging one of the light emitting point 1003b of the semiconductor laser 1030b and the light emitting point 1003c of the semiconductor laser 1030c on one aide (e.g. a left side or a right side) of the center axis 1300 of the objective lens 1304, and arranging the other of the light emitting point 1003b of the semiconductor laser 1030b and the light emitting point 1003c of the semiconductor laser 1030c on the other side (e.g. a right side or a left side) of the center axis 1300 of the objective lens 1304, it is possible to reduce the relative distances L2 and L3. This makes it possible to reduce the aberrations of the light spots formed from the light beams 1031b and 1031c. Further, it is possible to set such that the relative distance L2 is equal to the relative distance L3, when the recording/reproduction performance relative to the light spots formed from the light beams 1031b and 1031c is within a tolerable range for realizing a desired recording/reproduction performance.

Thus, according to the present embodiment, it is possible to realize a desired recording/reproduction performance with respect to the first, second and third optical discs having different formats, by optimally adjusting the light source module 1301c to sufficiently reduce the aberrations of the light spot formed from the light beam 1031a, which is required to be managed at the highest accuracy, such that the required recording/reproduction performance is realized for the first optical disc 1305a having a format of the highest density, and by setting the aberrations of the light spots formed from the light beams 1031b and 1031c within a tolerable range for realizing the desired recording/reproduction performance.

According to the present embodiment, it is not necessary to provide any optical element for matching the optical axis of the light beam passing through the light emitting point and the principal point of the collimating lens with the center axle of the objective lens, even if it is used as a light source module such as the light source module 1301 having a plurality of light emitting points which emit a plurality of light beams having different wavelengths. In addition, it is not necessary to adjust any parts associated with such an optical element.

Thus, a significant effect of providing an optical pickup apparatus which realizes a desired recording/reproduction performance with respect to three different optical discs can be obtained, wherein the optical pickup apparatus has a simple structure, a small size and a low cost.

Furthermore, in the present embodiment, since a plurality of light emitting points and a light detector is integrated in a the light source module 1301, further reduction in the number of parts is possible. This allows the realization of a compact and low-cost optical pickup apparatus, which realizes a desired recording/reproduction performance for a plurality of optical discs with a simple arrangement.

In the present embodiment, it is described a case where the light source module 1301 includes three semiconductor lasers, each of the three semiconductor lasers includes a single light emitting point, and the three semiconductor lasers emit the light beams 1301a, 1301b and 1301c having different wavelengths, respectively.

Alternatively, the light source module 1301 may include a single monolithic semiconductor laser for emitting three light beams having different wavelengths from three light emitting points.

Alternatively, the light source module may include a semiconductor laser for emitting a light beam having a first wavelength from a first light emitting point and a monolithic semiconductor laser having two emitting points for emitting a light beam having a second wavelength from a second light emitting point and for emitting a light beam having a third wavelength from a third light emitting point.

In these alternative cases, it is possible to reduce the number of semiconductor lasers mounted on the light source module by using a semiconductor laser for emitting two or three light beams. As a result, it is possible to simplify or omit some procedure such as an adjustment procedure of adjusting the position of the semiconductor lasers in producing the light source module, thereby reducing the cost of the light source module. In this case, an effect similar to the effect mentioned above can be obtained, by optimally adjusting the light source module such that the aberrations of the light spots formed from the light beam having the highest output among the three light beams is sufficiently reduced.

In the present invention, it is described a case where each light beam includes a single light beam. A light beam may be divided into a plurality of light beams using an optical element such as a hologram element. In this case, an effect similar to the effect mentioned above can be obtained, by applying the present invention to a main light beam among the plurality of light beams.

### Embodiment 6

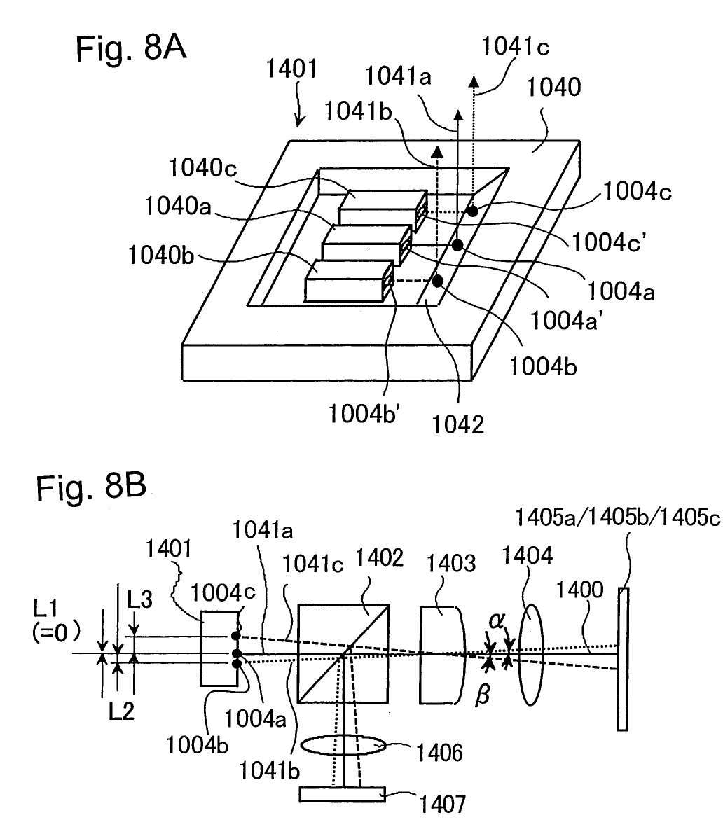

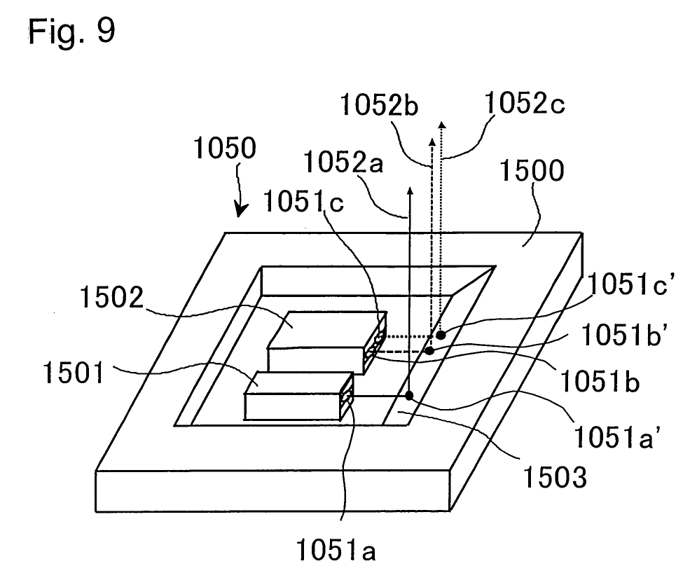

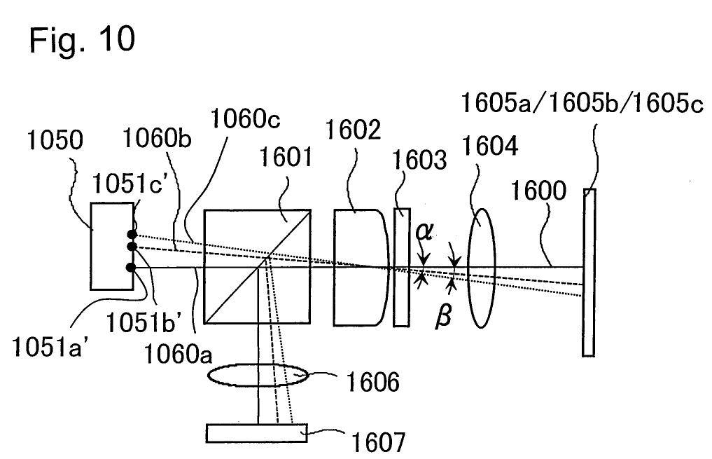

FIG. 8A shows another structure of a light source module used in an optical pickup apparatus according to an embodiment of the present invention. FIG. 8B shows another structure of an optical system using the light source module.

As shown in to FIG. 8A, a light source module 1401 includes a semiconductor laser 1040a for emitting a light beam 1041a having a maximum output power P1, a semiconductor laser 1040b for emitting a light beam 1041b having a maximum output power P2 and a semiconductor laser 1040c for emitting a light beam 1041c having a maximum output power P3.

The semiconductor lasers 1040a, 1040b and 1040c are mounted on a common substrate 1040 and are arranged to be in parallel.

The light beams 1041a, 1041b and 1041c are emitted from light emitting points 1004a′ 1004b′ and 1004c′ of the semiconductor lasers 1040a, 1040b and 1040c, respectively.

The light beams 1041a, 1041b and 1041c are used to perform a recording operation or a reproduction operation for a first optical disc 1405a, a second optical disc 1405b and a third optical disc 1405c, respectively. On the substrate 1040, a light detector 1407, which is divided into a plurality of portions, is integrated. The first, second and third optical discs have a format for the higher speed recording, in this order.

As shown in FIG. 8B, the light beams 1041a, 1041b and 1041c emitted from the light source module 1401 are transmitted through a beam-splitter 1402 and are converted into collimated light beams by a collimating lens 1403. The collimated light beams are converged onto the respective optical discs 1405a, 1405b and 1405c by the objective lens 1404 so as to form the respective light spots on the respective optical discs 1405a, 1405b and 1405c.

The objective lens 1404 may include a plurality of components each depending on the wavelength of the light beam or may be a single component which converges a plurality of light beams having different wavelengths onto the optical discs.

The reflected light beams reflected from the respective optical discs are transmitted through the objective lens 1404 and the collimating lens 1403, are reflected by the beam-splitter 1402, and converged on a light detector 1407 by a converging lens 1406. As a result, the light detector 1407 can detect various signals such as a tracking error signal and a focus error signal.

The detection of such various signals is easily realized based on the light beams entered into the light detector 1407, for example, using a focus detecting method such as an astigmatism or a tracking detecting method such as a push-pull method. Accordingly, the detailed description thereof are omitted with reference to FIGS. 8A and 8B. However, the effect of the present invention described below is not limited by these detecting methods and the structure of the optical system.

In FIG. 8B, reference numeral 1400 denotes a center axle of the objective lens 1404. In the example shown in FIG. 8B, a reference axis which optically matches the center axis of the objective lens 1404 is indicated by a solid line, since the reference axis overlaps with the light beam 1401a.

In general, when recording at a faster rotational speed of an optical disc, as the recording speed becomes faster, it is required to enhance the output of a light beam from a semiconductor and increase the power of a light spot on the optical disc. Therefore, it is required to increase the quality and precision of the light spot by reducing the aberrations of the light spot on the optical disc, when performing recording at a higher speed.

As the aberrations at the light spot formed on the optical disc has become larger, the power of the light beams drops.

As mentioned above, in the optical pickup apparatus according to the present embodiment, it is required to minimize the aberrations of the light spot formed from the light beam 1041a, which emits the highest output power, for the first optical disc 1405a, which performs a recording at the highest speed, and to manage the quality of the light spot at the highest precision and the highest accuracy and reduce the drop of power.

It is required to reduce the aberrations of the light spot formed from the light beam 1041b to improve the quality of the light spot, and then, it is required to reduce the aberrations of the light spot formed from the light beam 1041c so as to improve the quality of the light spot and reduce the drop of power.

When there is a distance L between the light emitting point of the semiconductor laser and the center axis of the objective lens (or the reference axis which optically matches the center axis of the objective lens), a light beam passing through the light emitting point of the semiconductor laser and the principal point of the collimating lens, is incident on the objective lens with a certain angle θ.

When the objective lens having a high numerical aperture is used to converge the light beams to form a light spot in the present embodiment, as the angle θ becomes larger, the aberrations of the light spot formed by converging the light beam onto the optical disc using the objective lens is increased so as to form a distorted light spot. As a result, the quality of the light spot is degraded, the power falls, and the recording performance is degraded.

According to the present embodiment, the light source module 1401 is configured after adjustment of two axes, such that, the light beam 1041a passing through the light emitting point 1004a of the semiconductor laser 1040a and the principal point of the collimating lens 1403, is incident on the objective lens 1404 with almost zero angle (i.e. such that the light emitting point 1004a is located on the center axis 1400 of the objective lens 1404) and the center axis of the diverging of the light beam approximately match the center axis of the objective lens. Thus, the light source module 1401 can be configured to minimize the aberrations of the light spot formed from the light beam 1041a and to optimize the quality of the light spot.

Further, the light source module 1401 is configured such that one of the light emitting point 1004b of the semiconductor laser 1040b and the light emitting point 1004c of the semiconductor laser 1040c is arranged on one side (e.g. a left side or a right side) of the center axis 1400 of the objective lens 1404, and the other of the light emitting point 1004b of the semiconductor laser 1040b, and the light emitting point 1004c of the semiconductor laser 1040c is arranged on the other aide (e.g. a right side or a left side) of the center axis 1400 of the objective lens 1404.

The light source module 1301 is configured to satisfy a relationship of L2<L3, where L2 denotes a relative distance between the light emitting point 1004b of the semiconductor laser 1040b and the center axis 1400 of the objective lens 1404, and L3 denotes a relative distance between the light emitting point 1004c of the semiconductor laser 1040c and the center axis 1400 of the objective lens 1404

That is, the light source module 1401 is configured to satisfy a relationship of L1=0, L2≠0, L3≠0 and L1<L2<L3, where L1 denotes a relative distance between the light emitting point 1004a of the semiconductor 1040a and the center axis 1400 of the objective lens 1404, L2 denotes a relative distance described above, and L3 denotes a relative distance described above.

In this case, because of L2≠0, the light beam 1041b, passing through the light emitting point 1004b of the semiconductor laser 1040b and the principal point of the collimating lens 1403, is incident on the objective lens 1404 with a certain angle α. This causes an aberration of the light spot formed by converging the light beam 1041b onto the second optical disc 1405b. Similarly, because of L3≠0, the light beam 1041c, passing through the light emitting point 1004c of the semiconductor laser 1040c and the principal point of the collimating lens 1403, is incident on the objective lens 1404 with a certain angle β. This causes an aberration of the light spot formed by converging the light beam 1041c onto the third optical disc 1405c. Accordingly, the quality of these light spots to degraded and the power of these light spots are reduced compared to the quality of an ideal light spot obtained in the case where L2=L3=0 (i.e. the light emitting points 1004b and 1004c are located on the center axis 1400 of the objective lens 1404 such that the angles α and β are equal to zero).

For the reasons mentioned above, it is required to reduce the aberrations of the light spot formed from the light beam 1041b so that the quality of the light spot is increased. In order to do so, it is necessary to reduce the relative distance L2 such that the angle α is reduced and to reduce the relative distance L3 such that the angle β is reduced, while the relationship of L2<L3 is maintained.

The distance between the light emitting point 1004b of the semiconductor laser 1040b and the light emitting point 1004c of the semiconductor laser 1040c, and the relative distances L2 and L3, are set such that the amount of the aberrations of the light spot formed from the light beam 1041b is within a tolerable range and the power of the light spot is obtained for realizing a desired recording performance with respect to the second optical disc 1405b, and the amount of the aberrations of the light spot formed from the light beam 1041c is within a tolerable range for obtaining a desired power of the light spot and realizing a desired recording performance with respect to the third optical disc 1405c. As a result, it is possible to obtain a desired power of the light spot and realize a desired recording performance with respect to the second and third optical discs 1405b and 1405c.

By arranging one of the light emitting point 1004b of the semiconductor laser 1040b and the light emitting point 1004c of the semiconductor laser 1040c on one side (e.g. a left side or a right side) of the center axis 1400 of the objective lens 1404, and arranging the other of the light emitting point 1004b of the semiconductor laser 1040b and the light emitting point 1004c of the semiconductor laser 1040c on the other side (e.g. a right side or a left side) of the center axis 1400 of the objective lens 1404, it to possible to reduce the relative distances L2 and L3. This makes it possible to reduce the aberrations of the light spots formed from the light beams 1041b and 1041c. Further, it to possible to set such that the relative distance L2 is equal to the relative distance L3, when the recording performance relative to the light spots formed from the light beams 1041b and 1041c, is within a tolerable range for realizing a desired recording performance.

Thus, according to the present embodiment, it is possible to realize a desired recording performance with respect to the first, second and third optical discs having different formats, by optimally adjusting the light source module 1401c to sufficiently reduce the aberrations of the light spot formed from the light beam 1041a and minimize the reduction of the power, which is required to be managed at the highest accuracy, such that the required recording performance is realized for the first optical disc 1405a performing recording at the highest speed, and by setting the aberrations of the light spots formed from the light beams 1041b and 1041c within a tolerable range for obtaining a desired power and realizing the desired recording performance.

According to the present embodiment, it is not necessary to provide any optical element for matching the optical axis of the light beam passing through the light emitting point and the principal point of the collimating lens with the center axis of the objective lens, even if it is used as a light source module such as the light source module 1401 having a plurality of light emitting points which emit a plurality of light beams having different wavelengths. In addition, it is not necessary to adjust any parts associated with such an optical element.

Thus, a significant effect of providing an optical pickup apparatus which realizes a desired recording performance with respect to three different optical discs can be obtained, wherein the optical pickup apparatus has a simple structure, a small size and a low cost.

In the present embodiment, it to described a case where the light source module 1401 includes three semiconductor lasers, each of the three semiconductor lasers includes a single light emitting point.

Alternatively, the light source module 1401 may include a single monolithic semiconductor laser for emitting three light beams having different outputs from three light emitting points.

Alternatively, the light source module 1401 includes three semiconductor lasers, each of the three semiconductor lasers includes a single light emitting point.

In the present embodiment, it is described a case where the light source module 1401 includes three semiconductor lasers, each of the three semiconductor lasers includes a single light emitting point.

Alternatively, in the present embodiment, the light source module 1401 may include a semiconductor laser for emitting a light beam having a first wavelength from a first light emitting point and a monolithic semiconductor laser having two emitting points for emitting a light beam having a second wavelength from a second light emitting point and for emitting a light beam having a third wavelength from a third light emitting point.

In these alternative cases, it is possible to reduce the number of semiconductor lasers mounted on the light source module by using a semiconductor laser for emitting two or three light beams. As a result, it to possible to simplify or omit some procedure such as an adjustment procedure of adjusting the position of the semiconductor lasers in producing the light source module, thereby reducing the cost of the light source module. In this case, an effect similar to the effect mentioned above can be obtained, by optimally adjusting the light source module such that the aberrations of the light spots formed from the light beam having the highest output power among the three light beams is sufficiently reduced.

In the present invention, it is described a case where each light beam includes a single light beam. A light beam maybe divided into a plurality of light beams using an optical element such as a hologram element. In this case, an effect similar to the effect mentioned above can be obtained, by applying the present invention to a main light beam among the plurality of light beams.

In addition, in the present embodiment, the light source module 1401 mounts a light detector for detecting a reflected light from the optical disc corresponding to the light beam emitted from the light emitting point mounted.

In addition, in the present embodiment, in the case that the light source module 1401 includes a light detector for detecting reflected light reflected from the optical disc corresponding to the light beam emitted from the light emitting points, and is integrated in a common package, a reduction of the number of parts is possible allows the realization of a compact and low-cost optical pickup apparatus, which realizes recoding/reproduction performance for three different optical discs.

In embodiments 4 to 6, the examples of a single light source module having three light emitting points has been described. However, as described in embodiments 1 and 2, it is possible that a light source module has two emitting points and the other light source module has one emitting point. In this case, under the condition that P1>P2>P3, as described in embodiments 1 and 2, a relationship of either L1=L2<L3 or L1<L2=L3 or L1<L2<L3 is satisfied, where P1, P2 and P3 denote the respective maximum output powers of the light beams emitted from the first, second and third light emitting points, and L1, L2 and L3 denote the respective distances between a reference axis which optically matches a center axis of the objective lens and the first, second and third light emitting points.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

### APPLICABILITY IN INDUSTRY

As mentioned above, the optical pickup apparatus of the present invention is useful as an optical pickup apparatus for an information recording/reproduction apparatus, and the like for optically recording or reproduction information using a laser light source in an information recording apparatus from an optical disc, and the like.

1. An optical pickup apparatus comprising:
a first, a second and a third light emitting points for emitting light beams;
an optical system for introducing the light beams emitted from the first, second and third emitting points to an objective lens;
an objective lens for converging the light beams introduced by the optical system onto an information recording medium; and
a light detector for detecting reflected light from the information recording medium,
wherein a relationship of λ1<λ2<λ3 is satisfied, where λ1, λ2 and λ3 denote the respective wavelengths of the light beams emitted from the first, second and third light emitting points, and
a relationship of either L1=L2<L3 or L1<L2=L3 or L1<L2<L3 is satisfied, where L1, L2 and L3 denote the respective distances between a reference axis which optically matches a center axis of the objective lens and the first, second and third light emitting points.

2. An optical pickup apparatus according to claim 1, wherein the third light emitting point and one of the first and second emitting points are integrated in a common package and the other of the first and second emitting points is integrated in another package different from the common package.

3. An optical pickup apparatus according to claim 2, wherein a relationship of L1=L2=0 and L3≠0 is satisfied.

4. An optical pickup apparatus according to claim 2, wherein a relationship of L1=0, L2≠0 and L3≠0 is satisfied.

5. An optical pickup apparatus according to claim 2, wherein at least one of the first, second and third light emitting points and the light detector are integrated in a common package and a relationship of L1<L2=L3 or L1<L2<L3 is satisfied.

6. An optical pickup apparatus according to claim 1, wherein the first, second and third light emitting points are integrated in the common package.

7. An optical pickup apparatus according to claim 6, wherein the light detector is further integrated in the common package.

8. An optical pickup apparatus comprising:
a first, a second and a third light emitting points for emitting light beams;
an optical system for introducing the light beams emitted from the first, second and third emitting points to an objective lens;
an objective lens for converging the light beams introduced by the optical system onto an information recording medium; and
a light detector for detecting reflected light from the information recording medium,
wherein a relationship of P1<P2<P3 is satisfied, where P1, P2 and P3 denote the respective maximum outputs of the light beams emitted from the first, second and third light emitting points, and
a relationship of either L1=L2<L3 or L1<L2=L3 or L1<L2<L3 is satisfied, where L1, L2 and L3 denote the respective distances between a reference axis which optically matches a center axis of the objective lens and the first, second and third light emitting points.

9. An optical pickup apparatus according to claim 8, wherein the third light emitting point and one of the first and second emitting points are integrated in a common package and the other of the first and second emitting point is integrated in another package different from the common package.

10. An optical pickup apparatus according to claim 9, wherein a relationship of L1=L2=0 and L3≠0 is satisfied.

11. An optical pickup apparatus according to claim 9, wherein a relationship of L1=0, L2≠0 and L3≠0 is satisfied.

12. An optical pickup apparatus according to claim 9, wherein at least one of the first, second and third light emitting points and the light detector are integrated in the common package and a relationship of either L1<L2=L3 or L1<L2<L3 is satisfied.

13. An optical pickup apparatus according to claim 8, wherein the first, second and third light emitting points are integrated in the common package.

14. An optical pickup apparatus according to claim 13, wherein the light detector is further integrated in the common package.
